(19) United States
(12) Patent Application Publication
(10) Pub. No.: US 2022/0289249 A1
(43) Pub. Date: Sep. 15, 2022

(54) VEHICLE DRIVING SYSTEM

(71) Applicant: DENSO CORPORATION, Kariya-city (JP)

(72) Inventor: Kouji IMAI, Kariya-city (JP)

(21) Appl. No.: 17/805,215

(22) Filed: Jun. 2, 2022

Related U.S. Application Data
(63) Continuation of application No. PCT/JP2020/040220, filed on Oct. 27, 2020.

(30) Foreign Application Priority Data
Dec. 6, 2019 (JP) 2019-221238

(51) Int. Cl. B60W 60/00; G05D 1/00; B60W 40/08

(52) U.S. Cl. CPC B60W 60/0053; G05D 1/0038; G05D 1/0016; B60W 40/08; B60W 60/0059; B60W 2556/45; B60W 2540/24; B60W 2420/42; B60W 2756/10

(57) ABSTRACT

A control-subject vehicle includes an information transmission unit that is configured to transmit a sensed image based on a result of sensing by a sensing unit and travel information to a wireless communication apparatus at a time when manual driving is performed, and a driving control unit that is configured to perform acceleration/deceleration control and steering control of the control-subject vehicle in response to a driving command from the wireless communication apparatus at the time when manual driving is performed, the wireless communication apparatus including an operation accepting unit that is configured to accept a driving operation regarding acceleration/deceleration control and steering control of the control-subject vehicle, driving operation being performed by the driver who operates the wireless communication apparatus, and a command transmission unit that transmits a command corresponding to driving operation as the driving command to the control-subject vehicle.

### CROSS-REFERENCE TO RELATED APPLICATION

This application is the U.S. bypass application of International Application No. PCT/JP2020/040220 filed on Oct. 27, 2020 which designated the U.S. and claims priority to Japanese Patent Application No. 2019-221238 filed on Dec. 6, 2019, the contents of both of which are incorporated herein by reference.

### TECHNICAL FIELD

The present disclosure relates to a vehicle driving system including a control-subject vehicle and a wireless communication apparatus.

### BACKGROUND

For example, as disclosed in JP 2014-019301 A, there has been proposed a technology for enabling, in case where a driver who is performing manual driving suddenly becomes ill, another occupant in, for example, a passenger's seat to urgently drive instead of the driver.

### SUMMARY

An aspect of the present disclosure provides a vehicle driving system including at least one wireless communication apparatus and a control-subject vehicle. The at least one wireless communication apparatus is possessed by a driver. The control-subject vehicle is capable of manual driving and autonomous driving, and is configured to be capable of performing manual driving in response to a command from the at least one wireless communication apparatus. In addition, the control-subject vehicle includes at least one sensing unit, an information detection unit, an information transmission unit, and a driving control unit.

The at least one sensing unit is configured to sense at least a side in an advancing direction as viewed from the control-subject vehicle to obtain a result of the sensing to generate an image to be displayed as viewed from a driver's seat of the control-subject vehicle. The information detection unit is configured to detect travel information of the control-subject vehicle. The information transmission unit is configured to transmit a sensed image based on the result of the sensing by the at least one sensing unit and travel information to the at least one wireless communication apparatus at a time when manual driving is performed. The driving control unit is configured to perform acceleration/deceleration control and steering control of the control-subject vehicle in response to a driving command from the at least one wireless communication apparatus at the time when manual driving is performed.

The at least one wireless communication apparatus includes an information acquisition unit, a display control unit, an operation accepting unit, and a command transmission unit. The information acquisition unit is configured to acquire the sensed image and travel information from the control-subject vehicle. The display control unit is configured to cause a display unit to display the sensed image and the image to be displayed based on travel information. The operation accepting unit is configured to accept a driving operation for acceleration/deceleration control and steering control of the control-subject vehicle, driving operation being performed by the driver who operates the at least one wireless communication apparatus. The command transmission unit is configured to transmit a command corresponding to driving operation as the driving command to the control-subject vehicle.

### BRIEF DESCRIPTION OF THE DRAWINGS

The above features of the present disclosure will be made clearer by the following detailed description, given referring to the appended drawings. In the accompanying drawings:

FIG. 1 is a block diagram of a configuration of a vehicle driving system according to a first embodiment;

FIG. 2 is a block diagram showing details of a configuration of an HMD (head-mounted type display apparatus) driving unit;

FIG. 3 is a plan view illustrating a relationship between images acquired from a vehicle and images to be displayed on an HMD;

FIG. 4 is a depiction of an example of the images to be displayed;

FIG. 5 is a flowchart showing a first half of a driving setting procedure according to the first embodiment;

FIG. 6 is a flowchart showing a latter half of the driving setting procedure;

FIG. 7 is a flowchart of an autonomous-mode procedure;

FIG. 8 is an explanatory table showing logic of switching driving modes;

FIG. 9 is a flowchart of an intra-vehicle HMD procedure;

FIG. 10 is a flowchart of an extra-vehicle HMD procedure;

FIG. 11 is a flowchart of an existing manual procedure;

FIG. 12 is a block diagram of a configuration of a vehicle driving system according to a second embodiment;

FIG. 13 is a block diagram showing a function of a communication diagnosis unit;

FIG. 14 is a flowchart of a communication-quality diagnosis procedure; and

FIG. 15 is a flowchart showing a first half of a driving setting procedure according to another embodiment.

### DETAILED DESCRIPTION OF THE PREFERRED EMBODIMENTS

Incidentally, in recent years, autonomous vehicles have been developed. The current autonomous vehicles need to be switched to manual driving in accordance with situations. Through intensive studies, the inventor has found a problem with the current autonomous vehicles that, depending on an autonomous driving level, drivers must always be seated in the driver's seat, and that a degree of freedom of movements of occupants and a degree of freedom of configurations such as arrangement of a steering wheel and pedals in the autonomous vehicles are restricted.

The present disclosure has been made to achieve an object to enable drivers to manually drive autonomous vehicles, and to increase a degree of freedom of configurations of the autonomous vehicles.

An aspect of the present disclosure provides a vehicle driving system including at least one wireless communication apparatus and a control-subject vehicle. The at least one wireless communication apparatus is possessed by a driver. The control-subject vehicle is capable of manual driving and autonomous driving, and is configured to be capable of performing manual driving in response to a command from the at least one wireless communication apparatus. In addition, the control-subject vehicle includes at least one sensing unit, an information detection unit, an information transmission unit, and a driving control unit.

The at least one sensing unit is configured to sense at least a side in an advancing direction as viewed from the control-subject vehicle to obtain a result of the sensing to generate an image to be displayed as viewed from a driver's seat of the control-subject vehicle. The information detection unit is configured to detect travel information of the control-subject vehicle. The information transmission unit is configured to transmit a sensed image based on the result of the sensing by the at least one sensing unit and travel information to the at least one wireless communication apparatus at a time when manual driving is performed. The driving control unit is configured to perform acceleration/deceleration control and steering control of the control-subject vehicle in response to a driving command from the at least one wireless communication apparatus at the time when manual driving is performed.

The at least one wireless communication apparatus includes an information acquisition unit, a display control unit, an operation accepting unit, and a command transmission unit. The information acquisition unit is configured to acquire the sensed image and travel information from the control-subject vehicle. The display control unit is configured to cause a display unit to display the sensed image and the image to be displayed based on travel information. The operation accepting unit is configured to accept a driving operation for acceleration/deceleration control and steering control of the control-subject vehicle, driving operation being performed by the driver who operates the at least one wireless communication apparatus. The command transmission unit is configured to transmit a command corresponding to driving operation as the driving command to the control-subject vehicle.

With such a configuration, as long as the control-subject vehicle and the at least one wireless communication apparatus are communicable with each other, manual driving of the control-subject vehicle can be performed by operating the at least one wireless communication apparatus irrespective of a position of the at least one wireless communication apparatus. Thus, a degree of freedom of configurations of the control-subject vehicle can be increased.

Hereinbelow, a first embodiment of the present disclosure is described with reference to the drawings.

### 1. Outline

First, an outline of the present disclosure is described. Hitherto, in automobiles, a seat for a driver who has a specific driving license is a dedicated place from which safe manual driving can be ensured (that is, a driver's seat). Also in the future of the field of the automobiles, there is a prediction that, as autonomous driving becomes prevalent, the limitation on a position of the driver's seat in vehicle structures will disappear. In view of such circumstances, the present disclosure provides a vehicle driving system 1 that is an “HMD driving operation system” that performs, without limiting a position of the driver, a switchover to manual driving for reasons such as abnormalities in a system of autonomous driving and performance limit of the system. An HMD 30 is a head-mounted type display apparatus. The HMD 30 may have a shape of any type such as a goggle type or a full-face helmet type as long as substantially an entirety of a field of view of a user can be covered with a display unit of the HMD 30.

The vehicle driving system 1 allows manual driving using the HMD 30 to be performed in cases where it is difficult to continue autonomous driving under responsibility of the system, in cases where difficulties in continuation of autonomous driving are predicted, or according to the driver's intention. In manual driving using the HMD 30, field-of-view information that is a minimum necessary for driving is provided to someone who has a driving license to perform manual driving by performing a driving operation with a controller 50, and who wears the HMD 30 on his/her head. With this, safe driving operation using the controller 50 is ensured.

In the vehicle driving system 1, autonomous driving mode and manual driving mode can be safely switched bidirectionally to each other irrespective of the position of the driver who has the driving license, specifically, whether the driver is in any of seats in a cabin or is outside of a vehicle.

Note that, in current systems of autonomous driving levels at which the driver has responsibility, in a case where the systems require the driver to perform a driving switchover to the driver, and then determine that performing the driving switchover properly cannot be ensured, it is essential to autonomously stop the vehicle at once. However, according to the present disclosure, as long as an appropriate driver is present at any of inside and outside of the vehicle, the switchover to manual driving in which the driver who wears the HMD 30 on his/her head performs driving operation with HMI tools can be performed without stopping the vehicle.

The vehicle driving system 1 according to the present disclosure properly selects and synthesizes, through viewpoint conversion, one or a plurality of images acquired by a camera unit 25 around the vehicle irrespective of whether the licensed driver is seated at any of inside and outside of the vehicle, and then projects the synthesized images onto the HMD 30. With this, the licensed driver can drive with a field of view exactly as in an existing field of view from the driver's seat.

### 2. Correspondences Between Configurations of this Embodiment and Configurations According to Present Disclosure

The HMD 30 and the controller 50 of this embodiment correspond to a wireless communication apparatus according to the present disclosure, and a vehicle 10 of this embodiment corresponds to a control-subject vehicle according to the present disclosure. Further, the camera unit 25 of this embodiment corresponds to an imaging unit according to the present disclosure, S1, S3, S4, S5, and S7 of this embodiment correspond to a first imaging unit according to the present disclosure, and S2 and S6 of this embodiment correspond to a second imaging unit according to the present disclosure. Still further, sensors 21 of this embodiment correspond to an information detection unit according to the present disclosure.

### 3. First Embodiment

Details of the above-described outline are described below.

[3-1. Hardware Configuration]

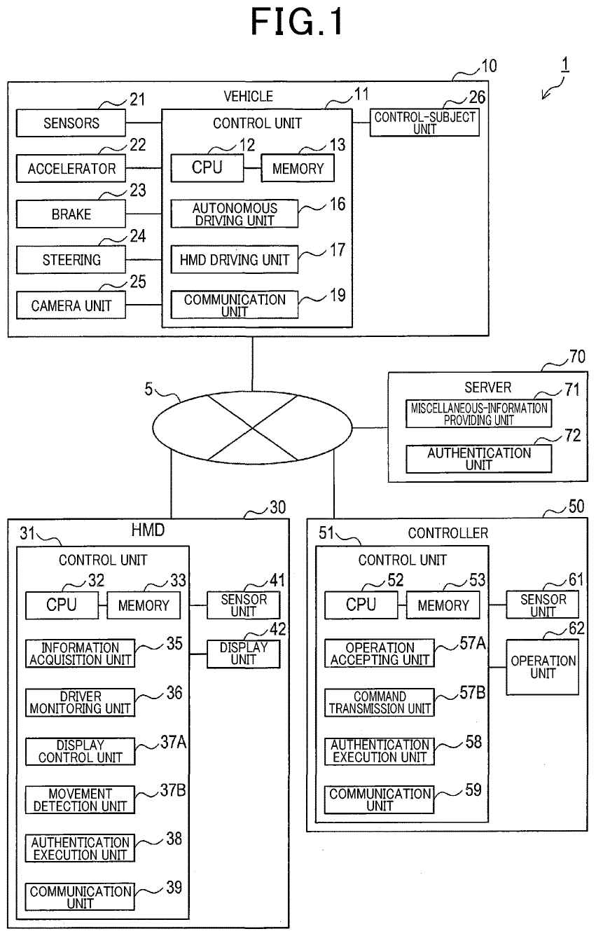

The vehicle driving system 1 shown in FIG. 1 includes the vehicle 10, the head-mounted type display apparatus (hereinafter, abbreviated as “HMD”) 30, and the controller 50. In addition, the vehicle driving system 1 may include a server 70.

The vehicle 10 is capable of performing autonomous driving and manual driving, and is configured to be capable of performing, as one of modes of manual driving, manual driving in response to a command from the wireless communication apparatus. In this embodiment, the HMD 30 and the controller 50 correspond to the wireless communication apparatus. The vehicle 10 is capable of performing autonomous driving without a driver taking responsibility. Autonomous driving without a driver taking responsibility refers to autonomous driving in which a forcible driving switchover to a driver is not performed as in the related art in case of the system abnormalities.

Thus, the driver need not be inside the vehicle 10. However, in case of emergency such as abnormalities of the vehicle 10, when the driver is in the driver's seat of the vehicle 10, or when this driver or another remote driver is present at an inside or an outside of the vehicle 10, depending on autonomous driving levels, these drivers are allowed to perform driving operation. Note that, when the appropriate driver is absent in case of the emergency of the vehicle 10, the vehicle 10 is safely stopped. In addition, even under a state in which autonomous driving can be performed, in response to an attempt to perform manual driving by an occupant, the vehicle 10 allows manual driving. The manual driving includes an existing manual mode and an intra-vehicle HMD mode described below.

The vehicle 10 includes a control unit 11, the sensors 21, an accelerator 22, a brake 23, a steering 24, the camera unit 25, and a control-subject unit 26.

The sensors 21 are configured to detect travel information of the vehicle 10. Travel information is information about travel of the vehicle 10. Travel information may include a vehicle speed, a steering angle, operating states of the accelerator and the brake, and an acceleration rate of the vehicle 10.

The accelerator 22 is an accelerator pedal that is arranged at the driver's seat of the vehicle 10. The brake 23 is a brake pedal that is arranged at the driver's seat of the vehicle 10. The steering 24 is a steering wheel that is arranged at the driver's seat of the vehicle 10. Contents of operations of these are recognized by the control unit 11, and the control unit 11 transmits commands corresponding to the contents of the operations to the control-subject unit 26.

The camera unit 25 is configured to capture at least a side in an advancing direction as viewed from the vehicle 10. Details of the camera unit 25 are described below.

The control-subject unit 26 is configured as an actuator that controls acceleration, deceleration, and steering of the vehicle 10. The control-subject unit 26 includes a driving motor that controls the acceleration and the deceleration, a fuel injection apparatus, a brake hydraulic-pressure control apparatus, a steering motor for controlling a steering angle.

The HMD 30 is an apparatus that is wirelessly communicable with the vehicle 10, and is for providing information which is necessary for remotely controlling the vehicle 10 as images to the driver. The HMD 30 is also an apparatus that is separated from the controller 50, that is configured to be mountable to the head of the driver, and that is possessed by the driver.

The HMD 30 includes a control unit 31, a sensor unit 41, and a display unit 42. The sensor unit 41 has a function to detect, for example, a position of the HMD 30, illuminance of surroundings, movements of eyes of the driver, whether the driver blinks his/her eyes, and an orientation of the head of the driver.

The display unit 42 is configured as a display that displays the images in accordance with commands from the control unit 31. The HMD 30 has an inner surface that covers most of the field of view of the driver by covering both the eyes of the driver from an outside. The display unit 42 displays the images on a display surface that is along this inner surface.

The controller 50 is the apparatus that is wirelessly communicable with the vehicle 10, and that accepts operations for driving the vehicle 10 by the driver. The controller 50 includes a control unit 51, a sensor unit 61, and an operation unit 62.

The sensor unit 61 has a function to detect voice, fingerprints, and the like of the driver. The operation unit 62 includes a plurality of buttons, switches such as a stick, a touchscreen, or the like that is provided to general controllers.

The control unit 11 of the vehicle 10, the control unit 31 of the HMD 30, and the control unit 51 of the controller 50 respectively include microcomputers that respectively include CPUs 12, 32, and 52 and a semiconductor memory such as a RAM or a ROM (hereinafter, abbreviated as “memories 13, 33, and 53”). Functions of the control units 11, 31, and 51 are implemented by causing the CPUs 12, 32, and 52 to execute programs that are stored in non-transitory solid-state recording media.

In this example, the memories 13, 33, and 53 correspond to the non-transitory solid-state recording media storing the programs. In addition, by executing the programs, methods corresponding to the programs are implemented. Note that, the non-transitory solid-state recording media refer to recording media excluding transient electromagnetic signals. In addition, the control units 11, 31, and 51 may each include the single microcomputer, or may include a plurality of microcomputers.

The control units 11, 31, and 51 includes units described below. A technique for implementing functions of these units is not limited to software, and some or all of the functions may be implemented by using one or a plurality of hardware modules. For example, when the functions are implemented by an electronic circuit as the hardware, this electronic circuit may be a digital circuit or an analog circuit, or may be a combination thereof.

The server 70 is an apparatus that provides, for example, information necessary for autonomous driving, or information necessary for authentication in the HMD 30 to the vehicle 10. The server 70 includes a miscellaneous-information providing unit 71 and an authentication unit 72.

The miscellaneous-information providing unit 71 contains map information, and provides the necessary data to the vehicle 10 in response to requests from the vehicle 10. The authentication unit 72 has pre-recorded license information, which is information about licensed drivers, and provides the license information to the vehicle 10 in response to the requests, for example, from the vehicle 10.

[3-2. Functions of Control Units 11, 31, and 51]

The control unit 11 of the vehicle 10 includes an autonomous driving unit 16, an HMD driving unit 17, and a communication unit 19. Autonomous driving unit 16 is configured to perform autonomous driving that does not need the operations by the driver.

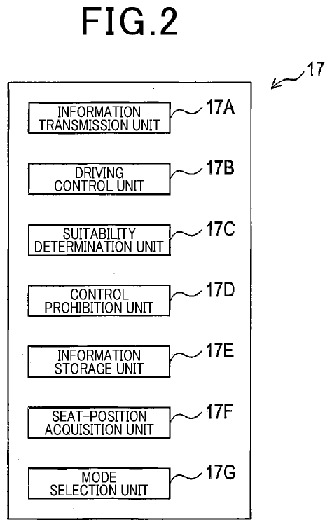

The HMD driving unit 17 is configured to implement functions for performing manual driving utilizing the HMD 30. As shown in FIG. 2, the HMD driving unit 17 includes an information transmission unit 17A, a driving control unit 17B, a suitability determination unit 17C, a control prohibition unit 17D, an information storage unit 17E, a seat-position acquisition unit 17F, and a mode selection unit 17G.

The information transmission unit 17A is configured to transmit the images that are acquired by the camera unit 25 and travel information to the HMD 30 at a time when manual driving using the HMD 30 is performed. The information transmission unit 17A acquires images that are acquired by the camera unit 25 and travel information that is acquired by the sensors 21, and then transmits the acquired images and travel information to the HMD 30 via the communication unit 19.

The driving control unit 17B is configured to perform acceleration/deceleration control and steering control of the vehicle 10 in response to driving commands from the controller 50 at the time when manual driving using the HMD 30 is performed. At this time, the driving control unit 17B converts a quantity of the operations to the operation unit 62, the quantity being included in driving commands, to a quantity for controlling the control-subject unit 26, and then transmits this control quantity as a control quantity for acceleration/deceleration control and a control quantity for steering control to the control-subject unit 26.

The suitability determination unit 17C determines, in a driving setting procedure described below, whether the driver is suited to driving of the vehicle 10.

The suitability determination unit 17C determines whether the driver has a license to drive the vehicle 10, and whether the driver is in a state of drunkenness. Whether the driver has the license is determined based on whether personal information (ID and security code or biometric information) of the driver matches registered information by performing communication with the server 70 with which information about licensed drivers has been registered. In addition, the state of drunkenness refers to a state in which normal driving may not be performed due to the influence of alcohol or drugs. Whether the driver is in the state of drunkenness is determined by comparing a drunkenness level with a preset threshold.

The drunkenness level indicates an extent of drunkenness of the driver and an extent of adverse effect of drugs. The drunkenness level is determined, for example, by observing the movements of the eyes of the driver with a driver monitoring unit 36 of the HMD 30. If the drunkenness level is acceptable, it is determined that the adverse effect of the alcohol and drugs is small. Note that, the drunkenness level may be determined by an alcohol sensor or the like.

The control prohibition unit 17D prohibits the driving control unit 17B from performing acceleration/deceleration control and steering control of the vehicle 10 if it is determined that the driver is not suited to driving. In S290 of the driving setting procedure described below, the control prohibition unit 17D forcibly causes the vehicle 10 to stop irrespective of the driver's intention.

The information storage unit 17E is configured to store the information for specifying the driver into a preset recording unit. In S310 of the driving setting procedure described below, the information storage unit 17E stores various information, for example, into the memory 13. Note that, a process of storing the information for specifying the driver into the preset recording unit need not necessarily be executed in the vehicle 10, but may be executed, for example, in the HMD 30, the controller 50, or another server.

The seat-position acquisition unit 17F is configured to acquire driver's-seat information for specifying a position of the driver's seat of the vehicle 10. A preset position in the vehicle 10 is recorded in the memory 13, and the seat-position acquisition unit 17F acquires information about this position as the driver's-seat information. The driver's-seat position may be changed at the driver's intention. For example, it is preferred that a right-hand drive vehicle or a left-hand drive vehicle be selectable.

In addition, the seat-position acquisition unit 17F may set an optimum position of the driver's seat in accordance with traffic divisions of roads on which the vehicle 10 travels. For example, it is preferred that a driver's seat of the right-hand drive vehicle be set for left-hand drive regions, and that a driver's seat of the left-hand drive vehicle be set for right-hand drive regions.

The mode selection unit 17G is configured to select, in the driving setting procedure, any mode from a plurality of driving modes in accordance with status of malfunction of the vehicle 10 and an intention of an occupant in the vehicle 10. Note that, in this embodiment, an autonomous mode, the intra-vehicle HMD mode, an extra-vehicle HMD mode, the existing manual mode, and the like are preset as the plurality of driving modes.

The autonomous mode is a mode in which the vehicle 10 is autonomously driven without the need for operations by the driver. The intra-vehicle HMD mode is a mode for letting the driver in the vehicle 10 perform manual driving using the HMD 30. In the intra-vehicle HMD mode, a configuration in which the HMD 30 and the vehicle 10 wirelessly communicate directly with each other without via the internet 5 may be adopted.

The extra-vehicle HMD mode is a mode in which the driver performs manual driving using the HMD 30 from outside of the vehicle 10. In the extra-vehicle HMD mode, communication via the internet 5 is performed.

The existing manual mode is a mode in which the driver manually drives the vehicle 10 using, for example, the pedals of the vehicle 10 without using the HMD 30 or the controller 50.

The communication unit 19 is configured as a known communication module for performing the communication via the internet 5. Note that, the communication unit 19 wirelessly communicates with a radio base station (not shown), and is connected to the internet 5 via a radio base station. In addition, a communication unit 39 of the HMD 30, and a communication unit 59 of the controller 50 are configured similar to the communication unit 19 of the vehicle 10.

As shown in FIG. 1, the control unit 31 of the HMD 30 includes an information acquisition unit 35, the driver monitoring unit 36, a display control unit 37A, a movement detection unit 37B, and the communication unit 39. When authentication is performed in the HMD 30, an authentication execution unit 38 may be provided.

The information acquisition unit 35 is configured to acquire the acquired images and travel information from the vehicle 10 via the communication unit 39.

The driver monitoring unit 36 monitors whether a condition of the driver is acceptable by using results of the detection by the sensor unit 41. For example, in response to a decrease in frequency of blinks of the driver, the driver monitoring unit 36 determines that the condition of the driver is poor. Note that, the driver monitoring unit 36 may monitor the condition of the driver by sensing biometric information such as a heart rate and blood pressure with use of a spectral camcorder. Other arbitrary monitoring techniques may be adopted.

The display control unit 37A is configured to cause the display unit 42 to display the acquired images and images to be displayed based on travel information. Details of the display control unit 37A are described below. The movement detection unit 37B is configured to detect movements of the head of the driver. The authentication execution unit 38 executes authentication by recognizing irises of the driver. Note that, other known authentication techniques than the iris recognition may be adopted.

The control unit 51 of the controller 50 includes an operation accepting unit 57A, a command transmission unit 57B, an authentication execution unit 58, and the communication unit 59. The authentication execution unit 58 and the communication unit 59 are configured similar to the authentication execution unit 38 and the communication unit 39 of the HMD 30.

The operation accepting unit 57A is configured to accept driving operation regarding acceleration/deceleration control and steering control of the vehicle 10, driving operation being performed by the driver who operates the operation unit 62. The operation accepting unit 57A has a function to detect the quantity of the operations of the operation unit 62.

The command transmission unit 57B is configured to transmit commands corresponding to driving operation as driving commands to the vehicle 10 via the communication unit 59.

[3-3. Displaying Images by Using HMD 30]

Now, driving operation using the HMD 30 is described.

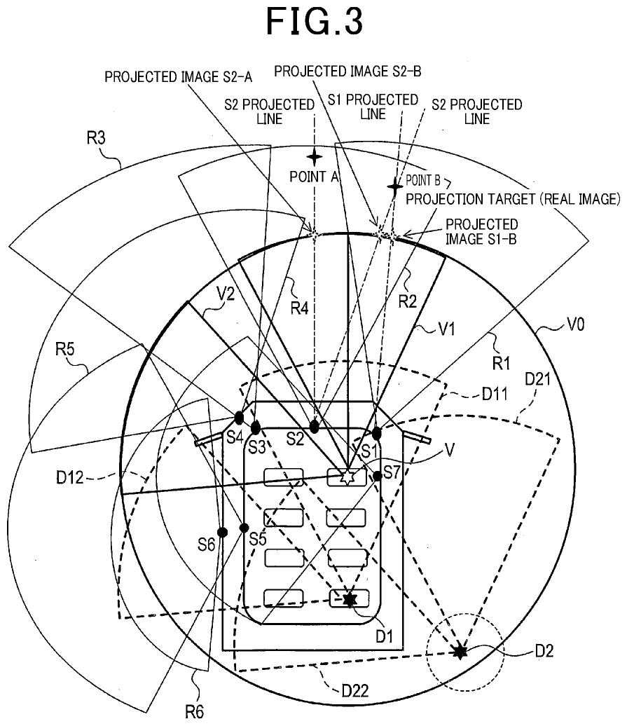

As illustrated in FIG. 3, the camera unit 25 includes a plurality of cameras S1 to S7. Note that, although some of the cameras are not shown in FIG. 3, the camera unit 25 is configured to be capable of monitoring surroundings of the vehicle with no blind spots by using a large number of cameras including the unshown ones of the cameras. Of the plurality of cameras S1 to S7, the camera S1, a camera S3, a camera S4, a camera S5, and the camera S7 are configured to perform sensing according to a first sensing method. For example, an imaging method using visible-light cameras may be adopted as the first sensing method. A camera S2 and a camera S6 are configured to perform sensing according to a second sensing method that is different from the first sensing method. For example, an imaging method using infrared cameras or spectral cameras may be adopted as the second sensing method.

Sensing areas of the cameras S1, S3, S4, S5, and S7 according to the first sensing method, and sensing areas of the cameras S2 and S6 according to the second sensing method cover the advancing direction of the vehicle 10 and lateral sides as viewed from the vehicle 10. Settings are made such that at least some of the sensing areas according to the different methods overlap with each other. Since the cameras S1 to S7 generate the acquired images, the sensing areas can be regarded also as imaging ranges.

Specifically, an imaging range R1 of the camera S1 and an imaging range R3 of the camera S3 are set to overlap with an imaging range R2 of the camera S2, and an imaging range R5 of the camera S5 is set to overlap with an imaging range R6 of the camera S6. When the plurality of cameras S1 to S7 are used as in this embodiment, the control unit 11 acquires, as sensed images, the images acquired by the plurality of cameras S1 to S7.

Note that, although the cameras that detect visible light and infrared light are employed as the cameras S1 to S7 in this embodiment, the cameras S1 to S7 may each be configured as an arbitrary sensing unit combined with radar (Lidar, millimeter waves) and sonar as long as results of the detection can be converted to images. Even if this sensing unit is incapable of directly generating the images, there is no problem as long as, for example, the control unit 11 converts results of the sensing to the images. Specifically, the control unit 11 may generate the images in accordance with positions of focus points that are determined by using the radar.

Note that, in the above-described configuration, another sensing method is used to make up for performance limit of a single sensing method. If the results of the sensing can be sufficiently obtained by one of the sensing methods, the one of the sensing methods may be employed alone.

The display control unit 37A generates one or a plurality of acquired images by synthesizing the acquired images to be obtained from the camera unit 25 with each other, and generates the images to be displayed as viewed from a driver's seat V of the vehicle 10 by subjecting the acquired images to coordinate conversion. In other words, with the cameras S1 to S7 arranged at positions other than that of the driver's seat V, the acquired images that have been subjected to the coordinate conversion are generated in a projection plane V0 that are projected on a sphere at a predetermined distance from the driver's seat V.

At this time, the display control unit 37A generates, as an image to be displayed V1 in front of the driver's seat, an image to be displayed corresponding to an initial position in an orientation of the head of the driver, the orientation being detected first by the movement detection unit 37B. For example, when an actual seating position of the driver is a back seat D1 of the vehicle 10, although a scene that the driver can actually recognize by sight falls within a range D11, the HMD 30 provides the image to be displayed V1 as viewed from the driver's seat V. Meanwhile, for example, when the actual seating position of the driver is outside D2 of the vehicle 10, although the scene that the driver can actually recognize by sight falls within a range D21, the HMD 30 similarly provides the image to be displayed V1 as viewed from the driver's seat V.

Note that, the display unit 42 of the HMD 30 includes a display device for the right eye and a display device for the left eye. These right-and-left display devices display parallax images having parallax in accordance with a distance to an object. The brain of the driver recognizes the right-and-left parallax images as a 3D image by synthesizing these parallax images with each other. Note that, in FIG. 3, for the sake of convenience, the projection plane V0 is illustrated as an imaginary center of parallax between the right eye and the left eye. The display control unit 37A inputs actual images to each of the display device for the right eye and the display device for the left eye. However, the parallax between the right eye and the left eye of varies among individuals, and hence the display control unit 37A may generate the parallax images to be input to the display device for the right eye and the display device for the left eye not in accordance with parallax between the right-and-left display devices of the HMD 30 but based on parallax that is calculated by automatically detecting positions of tails or corners of his/her eyes. With this, manual driving with the HMD worn can be performed as in viewing familiar 3D images, and HMD video sickness and wearing fatigue can be alleviated.

In addition, as at a point A in FIG. 3, when an object is detected only by the one camera S2, this object at the point A is uniquely specified by a projected line S2, and can be converted to a projected image S2-A in the projection plane V0 through the coordinate conversion. Meanwhile, as at a point B in FIG. 3, when an object is detected by a plurality of cameras, specifically, by the cameras S1 and S2, this object at the point B is doubly specified by a projected line S1 and the projected line S2, and hence cannot be uniquely specified.

In this case, the display control unit 37A adopts, for example, a projected line from a sensor that is at a shorter linear distance to the object than other linear distances from other ones of the cameras, or a projected line that has a lower frequency of generating distortion of the images synthesized with each other in the projection plane V0 than those of other ones of the projected lines. With this, the image can be uniquely specified by the projected line S1 or S2. The object at the point B can be converted to a projected image S1-B or a projected image S2-B in the projection plane V0 through the coordinate conversion. Note that, a position of the object in the projection plane V0 after the coordinate conversion has errors relative to a position that can actually be viewed from the driver's seat. Thus, it is appropriate for the display control unit 37A to correct the position of the object in the projection plane V0 in accordance with the distance to the object and with a distance between the sensor S1 or another one of the sensors to the driver's seat. Note that techniques that are similar to those applied to the projection plane V0 which is illustrated as a circle in this embodiment are applicable also to, for example, a spherical projection plane.

In addition, the display control unit 37A changes display ranges of the images to be displayed in a manner of following rightward and leftward movements of the head, the movements being detected by the movement detection unit 37B. For example, when the driver faces to the left relative to the initial position, and when the actual seating position of the driver is the back seat D1, although the scene that the driver can actually recognize by sight falls within a range D12, the HMD 30 provides an image to be displayed V2 as viewed from the driver's seat V. Meanwhile, for example, when the driver faces to the left relative to the initial position, and when the actual seating position of the driver is outside D2 of the vehicle 10, although the scene that the driver can actually recognize by sight falls within a range D22, the HMD 30 provides the image to be displayed V2 as viewed from the driver's seat V.

Note that, the display control unit 37A may change the display ranges of the images to be displayed not only in the manner of following the rightward and leftward movements of the head, but also in a manner of following upward and downward movements of the head, the movements being detected by the movement detection unit 37B.

The display control unit 37A causes the display unit 42 to display the visible-light images acquired by the cameras S1, S3, S4, S5, and S7, and the infrared images acquired by the cameras S2 and S6 while switching the visible-light images and the infrared images to each other in response to the commands from outside. For example, the operation unit 62 includes a changeover switch. In response to an operation to this switch, the display control unit 37A switches the visible-light acquired images and the infrared acquired images to each other.

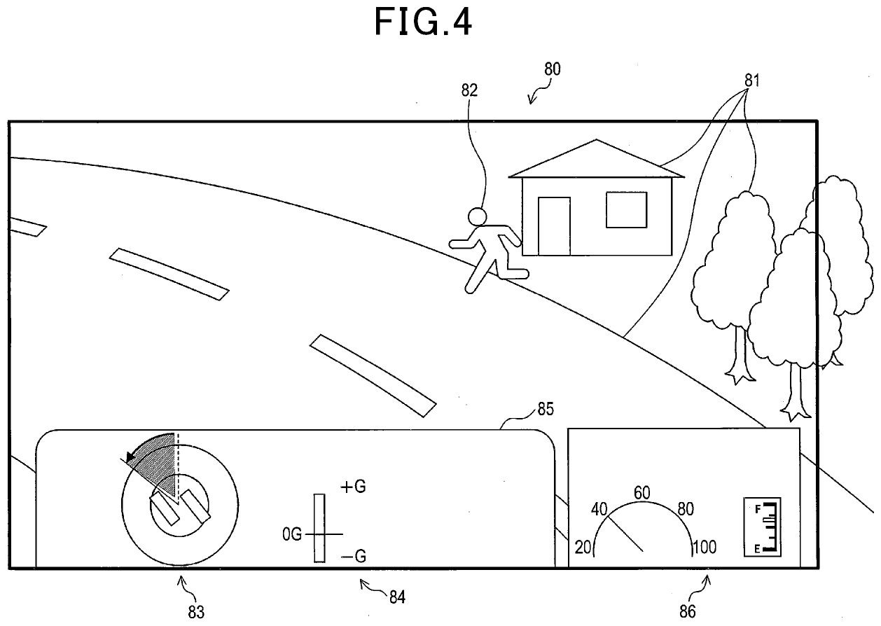

The display control unit 37A generates, for example, an AR image 80 as illustrated in FIG. 4 as the image to be displayed on the display unit 42. Note that, the “AR” is an abbreviation for “Augmented Reality.” The AR image 80 contains real images 81, a highlighted image 82, a guide image 85 containing a tire orientation image 83 and an acceleration-rate image 84, and a meter image 86.

The real images 81 are images to be displayed exactly as the images acquired by the camera unit 25. The highlighted image 82 is an image that substitutes for an object. The display control unit 37A generates the image that substitutes for the object by recognizing a type of an object depicted in the images acquired by the camera unit 25, and then replacing an image of the object with another image such as an icon corresponding to the type of the object.

The tire orientation image 83 is an image that depicts the steering angle of the vehicle 10 as orientations of tires. The acceleration-rate image 84 is an image that depicts an acceleration rate regarding the acceleration and the deceleration of the vehicle 10 as an indicator. The meter image 86 is an image that depicts meters of the speed, a remaining amount of fuel, and a coolant temperature, and the like of the vehicle 10.

In order that the AR image 80 is displayed, the information transmission unit 17A of the vehicle 10 is configured to first transmit the images acquired by the camera unit 25 and travel information to the HMD 30 at a time when manual driving using the HMD 30 is performed.

The information acquisition unit 35 of the HMD 30 is configured to then acquire the acquired images and travel information from the vehicle 10 via the communication unit 39. The display control unit 37A is configured to next cause the display unit 42 to display the acquired images and the images to be displayed based on travel information, that is, the AR image 80.

Note that, the images to be displayed on the display unit 42 are not limited to the AR image 80, and other arbitrary images such as a genuine live-action image or a complementary image that complements unclear parts behind a pillar or the like may be employed. In addition, under a state in which the operation accepting unit 57A is ready to accept driving operation, the display control unit 37A prohibits the display unit 42 from displaying specific images which are images of types that are preset as types of images which hinder driving operation.

For example, images broadcast on television, images of video games, images on web sites correspond to the specific images. In particular, in this embodiment, in the intra-vehicle HMD mode and the extra-vehicle HMD mode in each of which manual driving using the HMD 30 is performed, the display control unit 37A prohibits the display unit 42 from displaying images other than the AR image 80.

Meanwhile, under a state in which the operation accepting unit 57A is not ready to accept driving operation, that is, under a state in which someone other than the driver uses the HMD 30, the display control unit 37A allows the display unit 42 to display the specific images. In this case, the display control unit 37A may cause the display unit 42 to display arbitrary images.

[3-4. Driving Setting Procedure]

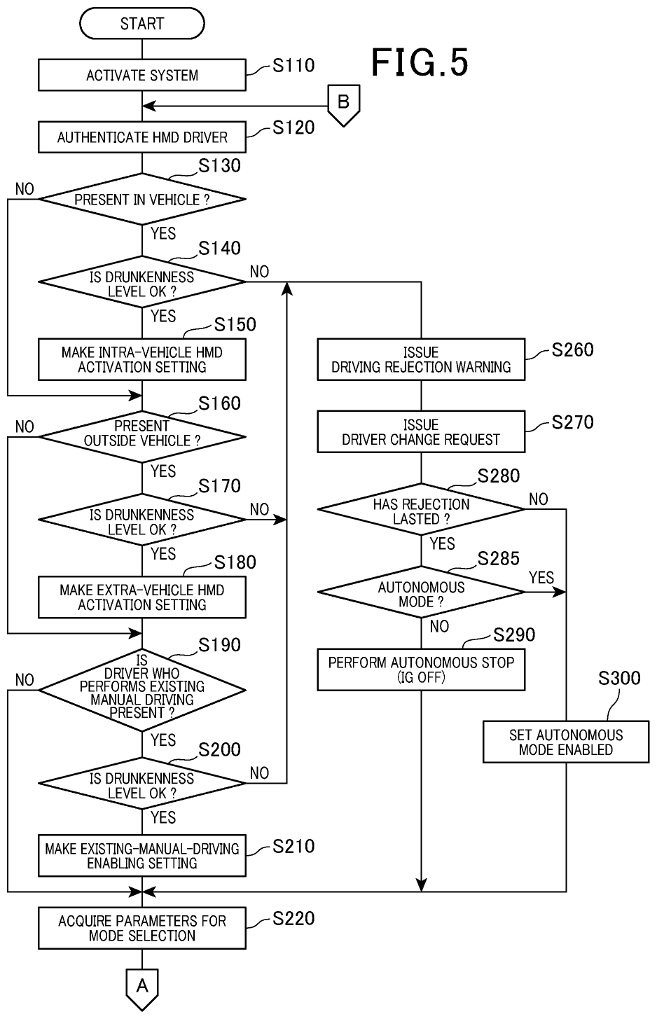

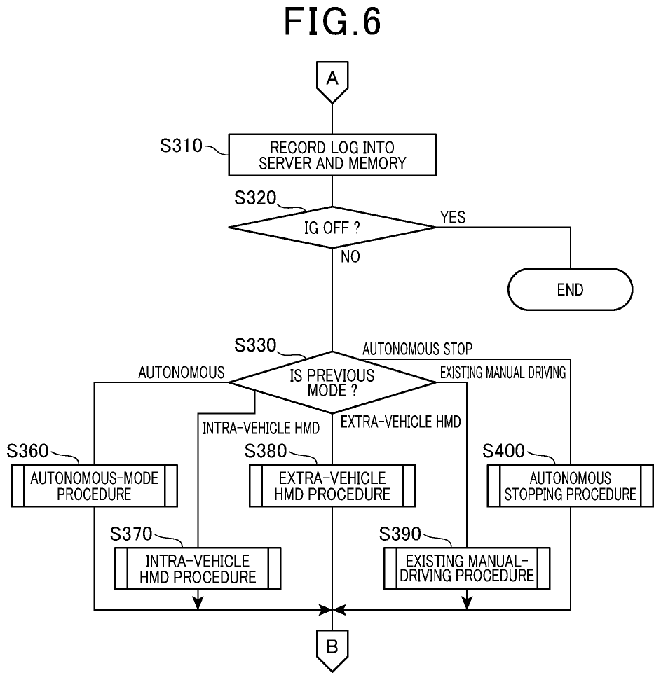

Next, the driving setting procedure to be executed by the control unit 11 of the vehicle 10, specifically, by the HMD driving unit 17 of the same is described with reference to flowcharts of FIG. 5 and FIG. 6. The driving setting procedure is a procedure for setting or switching the driving modes in accordance with a situation of the vehicle 10. The driving setting procedure is, for example, a procedure to be started in response to turning on of power source of the vehicle 10. Note that, in starting the driving setting procedure, the autonomous mode has been set as a previous driving mode.

In the driving setting procedure, first, in S110, the HMD driving unit 17 activates the vehicle driving system 1. At this time, the vehicle 10 establishes communication with the HMD 30, the controller 50, and the server 70.

Then, in S120, the HMD driving unit 17 authenticates the HMD driver. In this process, the vehicle 10 transmits authentication requests to the HMD 30, the controller 50, and the server 70. An at least one of the HMD 30 and the controller 50 that have received these authentication requests acquires biometric information of the driver, such as information about fingerprints, irises, and a contour of his/her face, and then transmits this information to the vehicle 10.

In addition, the server 70 transmits the information about the drivers recorded in the authentication unit 72 to the vehicle 10. The vehicle 10 identifies the information about the drivers recorded in the authentication unit 72 of the server 70 and biometric information transmitted from at least one of the HMD 30 and the controller 50 with each other, and authenticate that the driver is licensed.

Next, in S130, the HMD driving unit 17 determines whether the authenticated driver is present in the vehicle 10. For example, the HMD driving unit 17 acquires the position of the HMD 30 from the HMD 30, and then determines whether this position is located in the vehicle 10. If the HMD driving unit 17 determines in S130 that the authenticated driver is absent in the vehicle 10, the procedure proceeds to S160.

Meanwhile, if the HMD driving unit 17 determines in S130 that the authenticated driver is present in the vehicle 10, the procedure proceeds to S140. Then, the HMD driving unit 17 determines whether a drunkenness level of this driver is acceptable.

If the HMD driving unit 17 determines in S140 that the drunkenness level is unacceptable, the procedure proceeds to S260. Meanwhile, if the HMD driving unit 17 determines in S140 that the drunkenness level is acceptable, the procedure proceeds to S150. Then, the HMD driving unit 17 makes an intra-vehicle HMD activation setting for allowing the driving using the HMD 30 from inside of the vehicle 10.

Next, in S160, the HMD driving unit 17 determines whether the driver is present on outside of the vehicle 10. If the HMD driving unit 17 determines in S160 that the driver is absent on outside of vehicle 10, the procedure proceeds to S190.

Meanwhile, if the HMD driving unit 17 determines in S160 that the driver is present at outside of vehicle 10, the procedure proceeds to S170. Then, the HMD driving unit 17 determines whether the drunkenness level of this driver is acceptable. If the HMD driving unit 17 determines in S170 that the drunkenness level is unacceptable, the procedure proceeds to S260.

Meanwhile, if the HMD driving unit 17 determines in S170 that the drunkenness level is acceptable, the procedure proceeds to S180. Then, the HMD driving unit 17 makes an extra-vehicle HMD activation setting for allowing the driving using the HMD 30 from outside of the vehicle 10.

After that, in S190, the HMD driving unit 17 determines whether the manual driver who performs existing manual driving using the accelerator 22, the brake 23, and the steering 24 in the vehicle 10 is present. If the HMD driving unit 17 determines in S190 that the manual driver who performs the existing manual driving in the vehicle 10 is absent, the procedure proceeds to S220.

If the HMD driving unit 17 determines in S190 that the manual driver who performs the existing manual driving in the vehicle 10 is present, the procedure proceeds to S200. Then, the HMD driving unit 17 determines whether the drunkenness level of this driver is acceptable. If the HMD driving unit 17 determines in S200 that the drunkenness level is unacceptable, the procedure proceeds to S260.

If the HMD driving unit 17 determines in S200 that the drunkenness level is acceptable, the procedure proceeds to S210. Then, the HMD driving unit 17 makes an existing-manual-driving enabling setting for allowing the existing manual driving.

Then, in S220, the HMD driving unit 17 acquires parameters for the mode selection. These parameters are, for example, the driver's intention and the condition of the driver. The driver's intention may include intentions of other occupants. Among the parameters, the driver's intention is input, for example, via the operation unit 62. After this process, the procedure proceeds to S310.

Meanwhile, in S260, the HMD driving unit 17 issues a driving rejection warning. The driving rejection warning is a warning that driving operation by the driver is not accepted. In other words, the driving rejection warning is a notification that acceleration/deceleration control and steering control are prohibited. Then, in S270, the HMD driving unit 17 issues a driver change request. The drive change request is a request for prompting a change to another licensed driver.

The driving rejection warning and the driver change request are transmitted as warning images depicting these warning and request to the HMD 30. In response to the transmission of the warning images from the HMD driving unit 17 of the vehicle 10 to the HMD 30, in the HMD 30, the display control unit 37A causes the display unit 42 to display the warning images. In a case where another driver puts on the HMD 30 according to the warning images, after the procedure has returned to S120 and subsequent steps, the authentication is performed again with respect to the other driver.

After that, in S280, the HMD driving unit 17 determines whether a state of the driving rejection warning has lasted for a preset time period.

If the HMD driving unit 17 determines in S280 that the state of the driving rejection warning has not lasted for the preset time period, the procedure proceeds to S300. Meanwhile, if the HMD driving unit 17 determines in S280 that the rejection has lasted for the preset time period, the procedure proceeds to S285, and then the HMD driving unit 17 determines whether the previous driving mode is the autonomous mode.

If the HMD driving unit 17 determines in S285 that the previous driving mode is the autonomous mode, the procedure proceeds to S300, and then the HMD driving unit 17 sets the autonomous mode enabled. Then, the procedure proceeds to S220. If the HMD driving unit 17 determines in S285 that the current driving mode is not the autonomous mode, the procedure proceeds to S290, and the HMD driving unit 17 causes the vehicle 10 to be autonomously stopped. In other words, in a case where a driving operation by a driver who can perform safe driving cannot be expected, the vehicle 10 is stopped for safety. Next, the procedure proceeds to S220. Note that, in this case, after the vehicle 10 has been stopped, an ignition (that is, IG) is turned off.

After that, in S310, the HMD driving unit 17 records a log into the server 70 and the memory 13. At this time, the log contains information for specifying the driving mode and the driver. Note that, when the driver is present in the vehicle 10, an image of the driver in a mirror may be recorded. Then, the HMD driving unit 17 determines in S320 whether the ignition has been turned off.

If the HMD driving unit 17 determines in S320 that the ignition has been turned off, the driving setting procedure shown in FIG. 6 is ended. If the HMD driving unit 17 determines in S320 that the ignition has not been turned off, the procedure proceeds to S330. Then, the HMD driving unit 17 determines which of the modes the previous driving mode is.

If the HMD driving unit 17 determines in S330 that the previous driving mode is the autonomous mode, the procedure proceeds to S360. Then, the HMD driving unit 17 executes an autonomous-mode procedure, following which the procedure returns to S120. If the HMD driving unit 17 determines in S330 that the previous driving mode is the intra-vehicle HMD mode, the procedure proceeds to S370. Then, the HMD driving unit 17 executes an intra-vehicle HMD procedure, following which the procedure returns to S120.

If the HMD driving unit 17 determines in S330 that the previous driving mode is the extra-vehicle HMD mode, the procedure proceeds to S380. Then, the HMD driving unit 17 executes an extra-vehicle-HMD-mode procedure, following which the procedure returns to S120. If the HMD driving unit 17 determines in S330 that the previous driving mode is the existing manual mode, the procedure proceeds to S390. Then, the HMD driving unit 17 executes an existing-manual-driving procedure, following which the procedure returns to S120. If the HMD driving unit 17 determines in S330 that the previous driving mode corresponds to the state in which the vehicle is to be autonomously stopped, the procedure proceeds to S400. Then, the HMD driving unit 17 executes an autonomous stopping procedure, following which the procedure returns to S120. The autonomous stopping procedure is a procedure for safely stopping the vehicle 10, as which arbitrary procedures may be adopted. Thus, detailed description thereof is omitted.

[3-4-1. Autonomous-Mode Procedure]

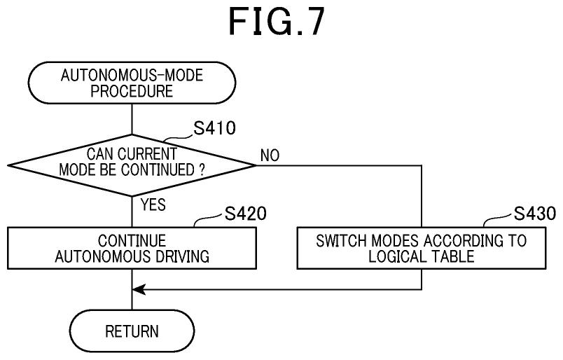

The autonomous-mode procedure to be executed by the HMD driving unit 17 is described with reference to a flowchart of FIG. 7. First, in S410, the HMD driving unit 17 determines whether the current driving mode can be continued. For example, the HMD driving unit 17 determines that the current driving mode can be continued if the vehicle 10 has not malfunctioned, and determines that the current driving mode cannot be continued if the vehicle 10 has somehow malfunctioned.

If the HMD driving unit 17 determines in S410 that the current driving mode can be continued, the procedure proceeds to S420. Then, the HMD driving unit 17 sets the autonomous mode continued, and the procedure returns to S410. Meanwhile, if the HMD driving unit 17 determines in S410 that the current driving mode cannot be continued, the procedure proceeds to S430. Then, the HMD driving unit 17 changes the driving mode according to a logical table, following which the autonomous-mode procedure shown in FIG. 7 is ended.

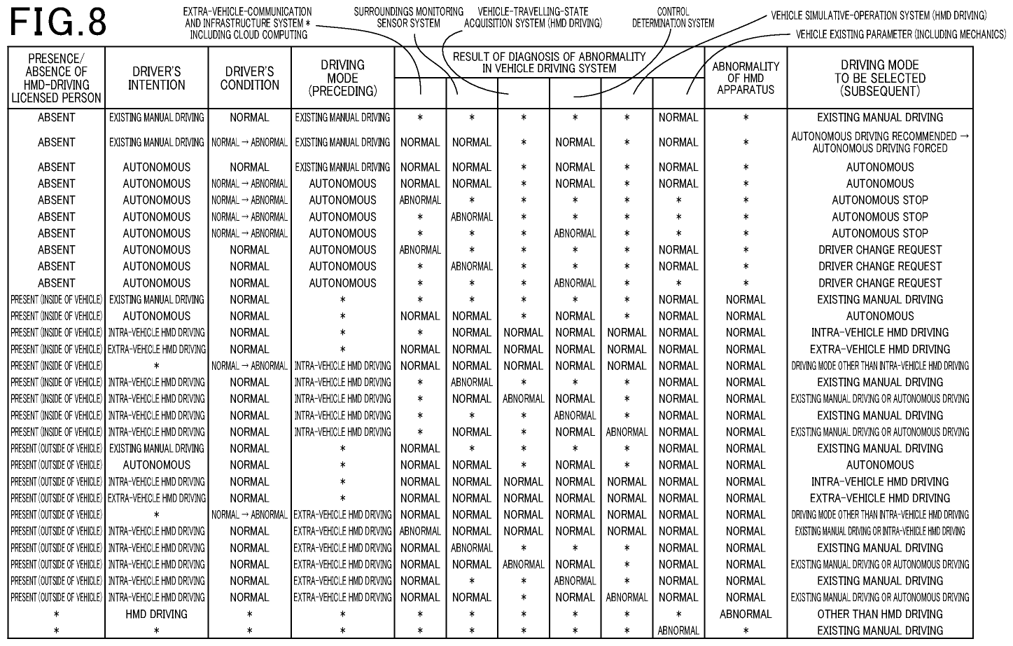

In this context, an example of the logical table is shown in FIG. 8. In the logical table shown in FIG. 8, settings are made such that a subsequent driving mode can be uniquely selected by specifying a combination of input items. Note that, the input items include presence/absence of HMD-driving licensed person, drivers' intentions, drivers' conditions, preceding driving modes, results of diagnoses of abnormalities in the vehicle driving system, and abnormalities of the HMD. In addition, symbols “*” in the logical table indicate arbitrary states/conditions/status.

In a column “PRESENCE/ABSENCE OF HMD-DRIVING LICENSED PERSON,” “PRESENT (INSIDE VEHICLE)” represents a state in which the intra-vehicle HMD activation setting has been made, “PRESENT (OUTSIDE VEHICLE)” represents a state in which the extra-vehicle HMD activation setting has been made, and “ABSENT” represents any other states than these states. A column “DRIVER'S INTENTION” shows items that are selected in advance by drivers as to in which of the driving modes he/she wants to drive. The contents to be detected in S140, S170, and S200 described above, and contents to be detected in S470 described below are adopted as the items to be shown in a column “DRIVER'S CONDITION.”

A column “RESULT OF DIAGNOSIS OF ABNORMALITY OF VEHICLE DRIVING SYSTEM” shows the status of the malfunction of the vehicle 10, that is, shows information about correlations between parts of the vehicle 10 and whether the malfunction has occurred. In the column “RESULT OF DIAGNOSIS OF ABNORMALITY IN VEHICLE DRIVING SYSTEM,” “VEHICLE-TRAVELLING-STATE ACQUISITION SYSTEM” and “VEHICLE SIMULATIVE-OPERATION SYSTEM” are systems essential to the HMD driving.

The “VEHICLE-TRAVELLING-STATE ACQUISITION SYSTEM” is a configuration including the communication unit 19 for acquiring, in the vehicle 10, the information to be obtained from the sensors 21, such as the vehicle speed. The “VEHICLE SIMULATIVE-OPERATION SYSTEM” is a configuration including the communication unit 19 for acquiring, from outside of the vehicle 10, the information about the operations to be input via the controller 50, and including the communication unit 59 of the controller 50.

The logical table shown in FIG. 8 is set based on concepts as follows.

[1] The manual driving includes the three modes of the existing manual mode, the intra-vehicle HMD mode (that is, intra-vehicle HMD driving), and the extra-vehicle HMD mode (that is, extra-vehicle HMD driving). If there are a plurality of drivers, in principle, the driving modes are selected in an order of the following priority. Note that, in a situation where it cannot be ensured that the condition of each of the drivers is “NORMAL,” from the driving modes, one mode that reflects the intention of a more reliable one of the drivers is selected.

AUTONOMOUS STOP>EXISTING MANUAL MODE>INTRA-VEHICLE HMD MODE>EXTRA-VEHICLE HMD MODE>AUTONOMOUS MODE

In other words, during manual driving, higher priority is given to drivers nearer the driver's seat.

[2] For example, although priority is given to the “EXISTING MANUAL MODE” in principle under a state in which the existing manual mode and the intra-vehicle HMD mode are selectable as a driving mode after a switchover, the “AUTONOMOUS MODE” is selected in a situation where a fact that the conditions of drivers in at least any one of the “EXISTING MANUAL MODE and INTRA-VEHICLE HMD MODE” are “NORMAL” cannot be ensured. In addition, in a situation where even a reliability of the “AUTONOMOUS MODE” is not ensured, the “AUTONOMOUS STOP” is selected.

[3] The priority settings in the concepts of the priority as described above in [1] and [2] may be varied in accordance with regulations and advancement of technology in the future so that higher safety can be ensured.

[4] “CONTROL DETERMINATION SYSTEM” is a function to perform control relating to safety of autonomous braking and the like. In case where abnormalities occur in the “CONTROL DETERMINATION SYSTEM,” none of the autonomous mode, the intra-vehicle HMD mode, and the extra-vehicle HMD mode is selected. In this case, if the system is under responsibility of the driver, the vehicle 10 is in the same state as those of existing vehicles that are incapable of autonomous driving.

[5] In the vehicle driving system 1, the drivers and the driving modes can be selected at a time of turning on the ignition. In addition, in the vehicle driving system 1, the drivers may switch with each other during a single trip until the ignition is turned off after the ignition has been turned on. In the selection of the drivers at the time of turning on the ignition, priority is given to licensed drivers in the vehicle by default. However, if there are no licensed drivers in the vehicle, the HMD driver may remotely turn on the ignition from outside of the vehicle.

[3-4-2. Intra-Vehicle HMD Procedure]

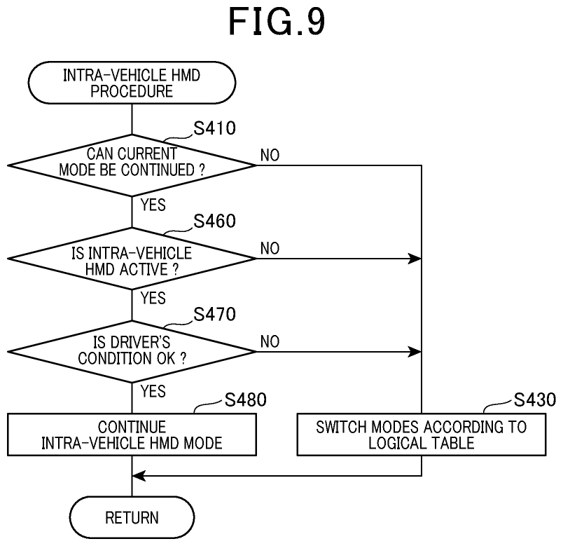

The intra-vehicle HMD procedure to be executed by the HMD driving unit 17 is described with reference to a flowchart of FIG. 9. First, as in the autonomous-mode procedure, in S410, the HMD driving unit 17 determines whether the current driving mode can be continued.

If the HMD driving unit 17 determines in S410 that the current driving mode cannot be continued, the procedure proceeds to S430. If the HMD driving unit 17 determines in S410 that the current driving mode can be continued, the procedure proceeds to S460. Then, the HMD driving unit 17 determines whether the intra-vehicle HMD is active. If the HMD driving unit 17 determines in S460 that the intra-vehicle HMD is inactive, the procedure proceeds to S430.

Meanwhile, if the HMD driving unit 17 determines in S460 that the intra-vehicle HMD is active, the procedure proceeds to S470. Then, the HMD driving unit 17 determines whether a driver's condition is acceptable. The driver's condition is determined by the driver monitoring unit 36. If the HMD driving unit 17 determines in S470 that the driver's condition is poor, the procedure proceeds to S430.

Meanwhile, if the HMD driving unit 17 determines in S470 that the driver's condition is acceptable, the procedure proceeds to S480. Then, the HMD driving unit 17 sets the intra-vehicle HMD mode continued, following which the intra-vehicle HMD procedure shown in FIG. 9 is ended. Incidentally, after the HMD driving unit 17 has changed the driving mode according to the logical table in S430 as in the autonomous-mode procedure, the intra-vehicle HMD procedure shown in FIG. 9 is ended.

[3-4-3. Extra-Vehicle HMD Procedure]

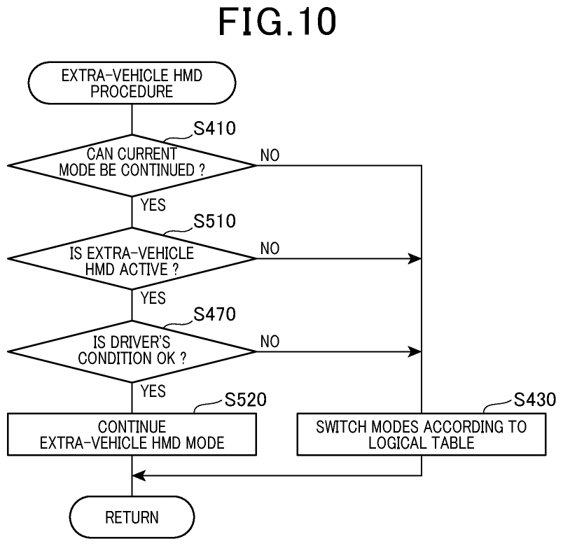

The extra-vehicle HMD procedure to be executed by the HMD driving unit 17 is described with reference to a flowchart of FIG. 10. First, as in the autonomous-mode procedure, in S410, the HMD driving unit 17 determines whether the current driving mode can be continued.

If the HMD driving unit 17 determines in S410 that the current driving mode cannot be continued, the procedure proceeds to S430. If the HMD driving unit 17 determines in S410 that the current driving mode can be continued, the procedure proceeds to S510. Then, the HMD driving unit 17 determines whether the extra-vehicle HMD is active. If the HMD driving unit 17 determines in S510 that the extra-vehicle HMD is inactive, the procedure proceeds to S430.

Meanwhile, if the HMD driving unit 17 determines in S510 that the extra-vehicle HMD is active, the procedure proceeds to S470. Then, the HMD driving unit 17 determines whether the driver's condition is acceptable. The driver's condition is determined by the driver monitoring unit 36. If the HMD driving unit 17 determines in S470 that the driver's condition is poor, the procedure proceeds to S430.

Meanwhile, if the HMD driving unit 17 determines in S470 that the driver's condition is acceptable, the procedure proceeds to S520. Then, the HMD driving unit 17 sets the extra-vehicle HMD mode continued, following which the extra-vehicle HMD procedure shown in FIG. 10 is ended. Incidentally, after the HMD driving unit 17 has changed the driving mode according to the logical table in S430 as in the autonomous-mode procedure, the extra-vehicle HMD procedure shown in FIG. 10 is ended.

[3-4-4. Existing Manual Procedure]

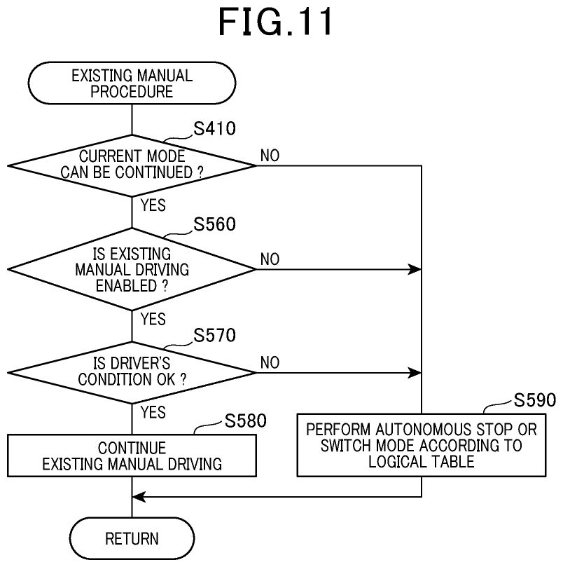

The existing manual procedure to be executed by the HMD driving unit 17 is described with reference to a flowchart of FIG. 11. First, as in the autonomous-mode procedure, in S410, the HMD driving unit 17 determines whether the current driving mode can be continued.

If the HMD driving unit 17 determines in S410 that the current driving mode cannot be continued, the procedure proceeds to S590.

Meanwhile, if the HMD driving unit 17 determines in S410 that the current driving mode can be continued, the procedure proceeds to S560. Then, the HMD driving unit 17 determines whether the existing manual driving is enabled. If the HMD driving unit 17 determines in S560 that the existing manual driving is disabled, the procedure proceeds to S590.

Meanwhile, if the HMD driving unit 17 determines in S560 that the existing manual driving is enabled, the procedure proceeds to S570. Then, the HMD driving unit 17 determines whether the driver's condition is acceptable. If the HMD driving unit 17 determines in S570 that the driver's condition is acceptable, the procedure proceeds to S580. Then, the HMD driving unit 17 sets the existing manual mode continued, following which the existing manual procedure shown in FIG. 11 is ended.

Meanwhile, if the HMD driving unit 17 determines in S570 that the driver's condition is poor, the procedure proceeds to S590. Then, the HMD driving unit 17 performs the autonomous stop, or performs settings to switch the driving mode according to the logical table. After that, the existing manual procedure shown in FIG. 11 is ended.

[3-5. Advantages]

According to the first embodiment described in detail above, the following advantages can be obtained.

(3a) According to an aspect of the present disclosure, the vehicle driving system 1 includes the at least one wireless communication apparatus and the vehicle 10. The HMD 30 and the controller 50 are provided as the at least one wireless communication apparatus. The at least one wireless communication apparatus is possessed by a driver. The vehicle 10 is capable of autonomous driving and manual driving, and is configured to be capable of performing manual driving in response to the command from the at least one wireless communication apparatus. In addition, the vehicle 10 includes the at least one camera unit 25, the sensors 21, the information transmission unit 17A, and the driving control unit 17B.

The at least one camera unit 25 is configured to capture at least the side in the advancing direction as viewed from the vehicle 10. The sensors 21 are configured to detect travel information of the vehicle 10. The information transmission unit 17A is configured to transmit the images that are acquired by the at least one camera unit 25 and travel information to the HMD 30 at the time when manual driving is performed. The driving control unit 17B is configured to perform acceleration/deceleration control and steering control of the vehicle 10 in response to the driving command from the controller 50 at the time when manual driving is performed.

The at least one wireless communication apparatus includes the information acquisition unit 35, the display control unit 37A, the operation accepting unit 57A, and the command transmission unit 57B. The information acquisition unit 35 is configured to acquire the acquired images and travel information from the vehicle 10. The display control unit 37A is configured to cause the display unit 42 to display the acquired images and the images to be displayed based on travel information. The operation accepting unit 57A is configured to accept driving operation regarding acceleration/deceleration control and steering control of the vehicle 10, driving operation being performed by the driver who operates the at least one wireless communication apparatus. The command transmission unit 57B is configured to transmit the commands corresponding to driving operation as driving commands to the vehicle 10.

With such a configuration, as long as the vehicle 10 and the at least one wireless communication apparatus are communicable with each other, manual driving of the vehicle 10 can be performed by operating the HMD 30 and the controller 50 irrespective of the position of the at least one wireless communication apparatus. Thus, a degree of freedom of configurations of the vehicle 10 can be increased.

(3b) According to the aspect of the present disclosure, the at least one wireless communication apparatus further includes the controller 50 and the HMD 30. The controller 50 includes the operation accepting unit 57A and the command transmission unit 57B. The HMD 30 is an HMD 30 that is separated from the controller 50, that is mountable to the head of the driver, and that includes the information acquisition unit 35, the display unit 42, and the display control unit 37A.

With such a configuration, a view angle at which information that is necessary for the driving is displayed can be increased. Thus, the driver can more safely recognize status of surroundings of the vehicle 10.

(3c) According to the aspect of the present disclosure, the HMD 30 further includes the movement detection unit 37B that is configured to detect the movements of the head of the driver. The display control unit 37A generates the images to be displayed as viewed from the driver's seat of the vehicle 10, and changes the display ranges of the images to be displayed in a manner of following the movements of the head, the movements being detected by the movement detection unit 37B.

With such a configuration, the images to be displayed are generated as images as viewed from the driver's seat by subjecting the images acquired by the at least one camera unit 25 to the coordinate conversion. Thus, the driver can recognize images by sight exactly as when being seated in the driver's seat of the vehicle 10. In addition, since the images to be displayed are generated in the manner of following the movements of the head of the driver, the images to be displayed can be provided in viewing directions as the driver wants. With this, the driver can easily check safety around the vehicle 10.

(3d) According to the aspect of the present disclosure, the seat-position acquisition unit 17F is configured to acquire driver's-seat information for specifying the position of the driver's seat of the vehicle 10. The display control unit 37A is configured to generate the images to be displayed from a viewpoint at a position specified based on the drive's-seat information.

With such a configuration, for example, optimum driver's-seat positions for driving can be acquired as the driver's-seat information in accordance with a position of the driver's seat of the right-hand drive vehicle, a position of the driver's seat of the left-hand drive vehicle, or the traffic divisions. In addition, the images to be displayed can be provided from viewpoints at these positions. Thus, the driver can more safely drive the vehicle 10.

(3e) According to the aspect of the present disclosure, in the vehicle 10, as a counterpart of a first manual mode (the intra-vehicle HMD mode and the extra-vehicle HMD mode) being the driving mode for performing manual driving using the HMD 30 and the controller 50, a second manual mode (the existing manual mode) being the driving mode for manually driving the vehicle 10 without using the HMD 30 and the controller 50 is prepared. The mode selection unit 17G is configured to select any driving mode from a plurality of driving modes including the first manual mode and the second manual mode in accordance with the status of the malfunction of the vehicle 10 and the intention of an occupant in the vehicle 10 at the time when any of autonomous driving and manual driving is performed.

With such a configuration, an optimum driving mode can be selected from the plurality of driving modes for manual driving in accordance with the status of the malfunction of the vehicle 10 and the intention of the occupant in the vehicle 10.

(3f) According to the aspect of the present disclosure, the suitability determination unit 17C is configured to determine whether the driver is suited to driving of the vehicle 10. The control prohibition unit 17D is configured to prohibit the driving control unit 17B from performing acceleration/deceleration control and steering control of the vehicle 10 in response to the determination that the driver is not capable of driving.

With such a configuration, drivers who are unsuited to the driving can be restricted from driving the vehicle 10.

(3g) According to the aspect of the present disclosure, the suitability determination unit 17C determines whether the driver is in the state of drunkenness.

With such a configuration, drivers who are in a state of drunkenness can be restricted from driving the vehicle 10.

(3h) According to the aspect of the present disclosure, the suitability determination unit 17C determines whether the driver has a license to drive the vehicle 10.

With such a configuration, drivers who do not have licenses can be restricted from driving the vehicle 10.

(3i) According to the aspect of the present disclosure, the information storage unit 17E is configured to store the information for specifying the driver into the preset recording unit.

With such a configuration, in case where an accident is caused, for example, by errors in operating the vehicle 10, a driver and a selected one of the driving modes including the autonomous mode in this case can be easily specified.

(3j) According to the aspect of the present disclosure, the at least one camera unit 25 includes the cameras S1, S3, S4, S5, and S7, and the cameras S2 and S6. The cameras S1, S3, S4, S5, and S7 are configured to perform the sensing according to the first sensing method. The cameras S2 and S6 are configured to perform the sensing according to the second sensing method that is different from the first sensing method. The display control unit 37A causes the display unit 42 to display an at least one of the images acquired by the cameras S1, S3, S4, S5, and S7, and the images acquired by the cameras S2 and S6 while switching these images to each other in response to the commands from outside.

With such a configuration, display can be performed according to a sensing method that is selected to facilitate the visual recognition by the driver.

(3k) According to the aspect of the present disclosure, the display control unit 37A may prohibit the display unit 42 from displaying specific images under the state in which the operation accepting unit 57A is ready to accept driving operation, the specific images being images of types that are preset as types of images which hinder driving operation, and may allow the display unit 42 to display the specific images under the state in which the operation accepting unit 57A is not ready to accept driving operation.

With such a configuration, at a time when driving operation is performed, images which hinder driving operation can be suppressed from being displayed on the display unit 42. Thus, the driver can more safely perform driving operation. In addition, at a time when driving operation is not performed, the display unit 42 can be utilized for displaying arbitrary images other than those of driving operation.

### 4. Second Embodiment

[4-1. Difference from First Embodiment]

A second embodiment is the same as the first embodiment in basic configuration, and hence differences therebetween are described below. Note that, the same reference symbols as those described in the foregoing first embodiment denote the same components so that reference to the foregoing description is made.

The description in the foregoing first embodiment is made on a premise that status of the communication between the HMD 30 and the vehicle 10 or status of the communication between the controller 50 and the vehicle 10 is acceptable. In contrast, the second embodiment is different from the first embodiment in that a case where the status of the communication is poor can be coped with on a premise that the status of the communication may not be acceptable.

[4-2. Configuration]

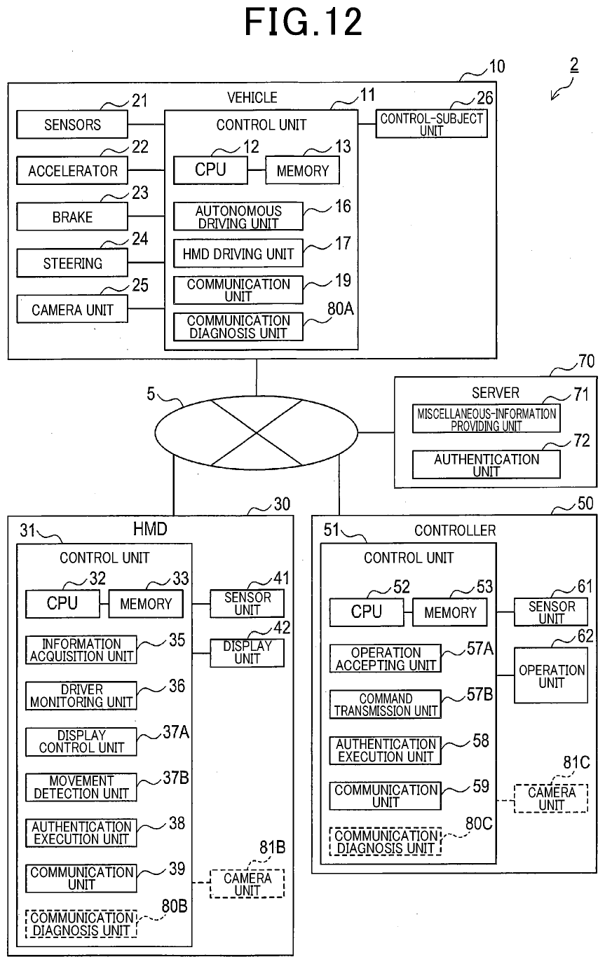

As shown in FIG. 12, in a vehicle driving system 2 according to the second embodiment, unlike the vehicle driving system 1 according to the first embodiment, the vehicle 10 includes a communication diagnosis unit 80A. The communication diagnosis unit 80A has a function to diagnose the status of the communication between the vehicle 10 and the HMD 30, and the status of the communication between the vehicle 10 and the controller 50. The communication status is diagnosed by a communication-quality diagnosis procedure described below.

Note that, hereinbelow, a procedure of diagnosing the status of the communication between the vehicle 10 and the HMD 30 is described, and a procedure of diagnosing the status of the communication between the vehicle 10 and the controller 50 is not described. The status of the communication between the vehicle 10 and the controller 50 can be described by replacing the HMD 30, which is a communication counterpart in the procedure of diagnosing the status of the communication between the vehicle 10 and the HMD 30, with the controller 50.

In other words, the vehicle 10 is a first apparatus according to the present disclosure, and the HMD 30 or the controller 50 is a second apparatus according to the present disclosure. According to another aspect of the present disclosure, the second apparatus is configured to return prepared test data as it originally is to the first apparatus in response to the reception of the prepared test data from the first apparatus. In this embodiment, the images acquired by the camera unit 25 are used as test images, and data of these test images is used as the test data.

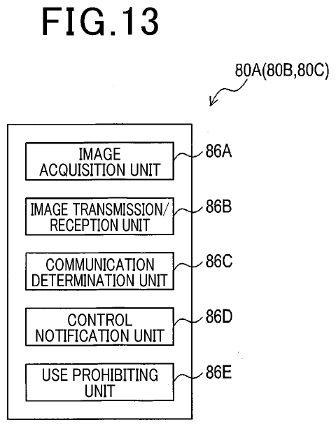

As shown in FIG. 13, in order to implement the function to diagnose the communication status, the communication diagnosis unit 80A includes an image acquisition unit 86A, an image transmission/reception unit 86B, a communication determination unit 86C, a control notification unit 86D, and a use prohibiting unit 86E. These units 86A to 86E constituting the communication diagnosis unit 80A are described below.

[4-3. Procedure]

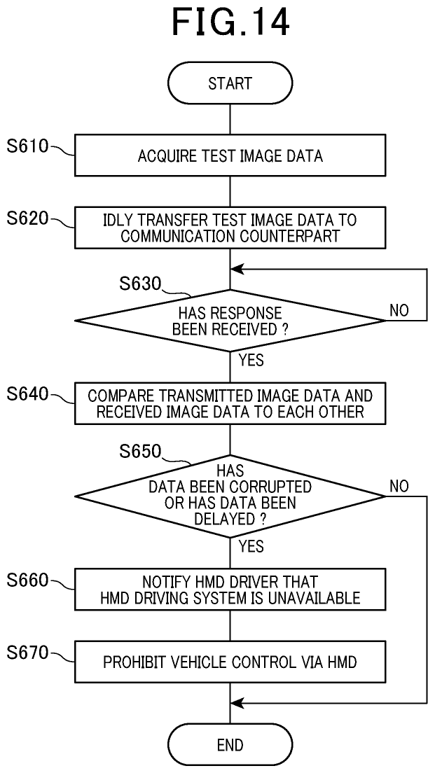

Next, the communication-quality diagnosis procedure to be executed by the control unit 11 in the vehicle 10 of the second embodiment is described with reference to a flowchart of FIG. 14. The communication-quality diagnosis procedure is a procedure to be executed at an arbitrary timing such as a timing immediately before executing the driving setting procedure, before performing manual driving, or during performing manual driving.

As shown in FIG. 14, in the communication-quality diagnosis procedure, first, in S610, the image acquisition unit 86A acquires the images acquired by the camera unit 25. Then, in S620, the image data transmission unit 86b idly transfers the images acquired by the camera unit 25 as the test image data to the communication counterpart. The “idle transfer” refers to transmission of the test image data to the communication counterpart together with a request for returning as it originally is the data that the communication counterpart has received.

In the case of this embodiment, in response to the transmission of the test image data from the vehicle 10 to the HMD 30, the HMD 30 returns the received test-image data as it originally is to the vehicle 10. Note that, the image data transmission unit 86b causes the memory 13 to maintain a time of the transmission of the test image data.

Next, in S630, the communication determination unit 86C determines whether a response of the test image data has been received. If the response of the test image data has not been received, the procedure returns to S630. Meanwhile, if the response of the test image data has been received, the procedure proceeds to S640. Then, the communication determination unit 86C compares the test image data transmitted from the vehicle 10 and the test image data returned from the HMD 30 to each other. Specifically, the communication determination unit 86C calculates a matching degree of the test image data transmitted from the vehicle 10 and the test image data received by the vehicle 10, that is, integrity of the test image data. Low integrity of the test image data indicates that the test image data has been corrupted during communication.

After that, in S650, the communication determination unit 86C determines whether the status of the communication between the vehicle 10 and the HMD 30 is acceptable based on the integrity of the test image data and a time lag from the transmission of the test image data by the vehicle 10 to the reception of the test image data from the HMD 30.

Note that, a determination based on the integrity of the test image data by the communication determination unit 86C that the communication status is acceptable is made if, for example, the matching degree of the data is equal to or more than a threshold (for example, 99.9%), and a determination based on the integrity of the test image data by the communication determination unit 86C that the communication status is poor is made if, for example, the matching degree is less than the threshold.

In addition, a determination based on the time lag by the communication determination unit 86C that the communication status is acceptable is made if, for example, a time period from the transmission of the test image data to the reception of the data by the vehicle 10 is less than a threshold (for example, 10 ms), and a determination based on the time lag by the communication determination unit 86C that the communication status is poor is made if, for example, the time period is equal to or more than the threshold.

Note that, in this embodiment, the communication determination unit 86C determines that the communication status is acceptable overall if the communication status is acceptable based on both the integrity of the test image data and the time lag. Meanwhile, the communication determination unit 86C determines that the communication status is poor overall if the communication status is poor based on the integrity of the test image data or the time lag.

If the communication status is acceptable in S650, the procedure is ended. Meanwhile, if the communication status is poor in S650, the procedure proceeds to S660. Then, the control notification unit 86D notifies the driver who operates the HMD 30 that the HMD driving system is unavailable, that is, notifies that acceleration/deceleration control and steering control of the vehicle 10 by the driving control unit 17B are prohibited. This notification is provided by transmitting images, textual information, and information by means of voice and the like to an at least one of the HMD 30 and the controller 50. In response to reception of the images, the textual information, and the information by means of voice and the like by the HMD 30 and the controller 50, the HMD 30 and the controller 50 output the received information to the driver via the display, a speaker, and the like.

Next, in S670, the use prohibiting unit 86E sets the driving control unit 17B prohibited from performing acceleration/deceleration control and steering control of the vehicle 10. For example, the HMD activation settings in the processes of S150 and S180 described above are cancelled. With this, the HMD 30 is set unavailable. After S670, the procedure is ended.

[4-4. Advantages]

According to the second embodiment described in detail above, in addition to the advantage (3a) described above in the first embodiment, the following advantages can be obtained.

(4a) According to the other aspect of the present disclosure, one of the HMD 30 (or controller 50) and the vehicle 10 is the first apparatus, and another one of the HMD 30 (or controller 50) and the vehicle 10 is the second apparatus. The vehicle driving system 2 according to the second embodiment includes the image data reception unit 86b, the communication determination unit 86C, and the use prohibiting unit 86E.

The image data reception unit 86b is arranged in the first apparatus, and is configured to receive the prepared test data from the second apparatus before manual driving is performed, or while manual driving is being performed.

The communication determination unit 86C is configured to determine whether the status of the communication between the first apparatus and the second apparatus is acceptable based on the status of the reception of the test data.

The use prohibiting unit 86E is configured to prohibit the driving control unit 17B from performing acceleration/deceleration control and steering control of the vehicle 10 in response to the determination by the communication determination unit 86C that the status of the communication is poor.

With such a configuration, since acceleration/deceleration control and steering control of the vehicle 10 by the driving control unit 17B are prohibited under the state in which the communication status is poor, the vehicle 10 can be prevented from being uncontrollable due to interruption of the communication during the control of the vehicle 10 by the driving control unit 17B.

(4b) According to the other aspect of the present disclosure, the second apparatus is configured to return the prepared test data as it originally is to the first apparatus in response to the reception of the prepared test data from the first apparatus. In addition, the vehicle driving system 2 further includes the image data transmission unit 86b that is arranged in the first apparatus and that is configured to transmit the test data to the second apparatus.

The communication determination unit 86C is configured to determine whether the status of the communication between the first apparatus and the second apparatus is acceptable based on an at least one of the integrity of the test data transmitted by the first apparatus and the test data returned from the second apparatus, and the time lag from the transmission of the test data by the first apparatus to the reception of the test data from the second apparatus.

With such a configuration, since the communication status is determined using the integrity of the transmitted test data and the returned test data and the time lag, the communication status can be determined more accurately than in a configuration in which the test data is merely received.

(4c) According to the other aspect of the present disclosure, the first apparatus further includes the image acquisition unit 86A. The image acquisition unit 86A is configured to acquire the images acquired by the at least one camera unit 25 and images acquired by camera units 81B and 81C. The image data transmission unit 86b is configured to transmit the image data including the acquired images as the test data.

With such a configuration, since the images acquired by the camera units are transmitted as the test data, the determination can be performed by using constantly-different test data.

### 5. Another Embodiment

The present disclosure is not limited to the above-described embodiments, and may be embodied with various modifications.

(5a) The suitability determination unit 17C of the vehicle 10 need not necessarily determine whether the driver is suited to the driving of the vehicle 10 as in the configurations of the embodiments mentioned above. For example, the HMD 30, the controller 50, another server, or the like may determine whether the driver is suited to the driving of the vehicle 10.

In addition, at the time of the license authentication, seating in a designated driver's seat may be detected, and warning may be issued if the driver is not seated therein. Alternatively, the driver may be allowed to be freely seated as he/she likes after the authentication, that is, the authentication may be performed only once. Still alternatively, the license authentication may be performed by communication with an external server.

(5b) The information storage unit 17E of the vehicle 10 need not necessarily record logs as in the configurations of the above-described embodiments. For example, a configuration in which the information storage unit 17E that records the logs is provided, for example, in the server 70 or the HMD 30 may be adopted.

(5c) The vehicle 10 need not necessarily include the driver's seat provided with the accelerator 22, the brake 23, and the steering 24 as in the above-described embodiments.

(5d) Unlike the above-described embodiments in which some of the images generated by synthesizing the images acquired by the plurality of cameras S1 to S7 are generated as the images to be displayed, the cameras S1 to S7 themselves may have movable structures so that the cameras S1 to S7 are oriented in conjunction with the movements of the head of the driver wearing the HMD 30.

(5e) The at least one camera unit 25 may have a telescopic function and a local magnification function. In this configuration, the telescopic function and the local magnifying function are selectable in displaying the images on the HMD 30.

(5f) Some of the surroundings monitoring sensors may be mounted to the HMD 30. In this case, it is preferred that the vehicle 10 acquire results of detection by the surrounding monitoring sensors from the HMD 30.

(5g) The HMD 30 and the controller 50 may be used not only for the communication with the vehicle 10. For example, the HMD 30 and the controller 50 may function as medical apparatuses by communicating with robots on remote sites. Alternatively, the HMD 30 and the controller 50 may be used in performing driving operations of movable bodies other than the vehicle 10.

(5h) The controller 50 may be configured to be capable of operating turn signals, windshield wipers, and the like of the vehicle 10.

(5i) The HMD 30 and the controller 50 need not necessarily be configured as independent wireless-communication terminals that are communicable with the vehicle 10 as in the above-described embodiments. For example, the HMD 30 and the controller 50 may be configured integrally with each other as the at least one wireless communication apparatus such as a tablet terminal.

(5j) In addition, the embodiments mentioned above may be applied to configurations as described below.

(5j-1) A viewpoint of the licensed driver in a front driver's seat during the HMD driving may be switched around a fixed default value, or may be switched at the intention of the licensed driver.

(5j-2) There may be provided means for detecting where the licensed driver is seated on inside or outside of the vehicle, and authenticating the HMD driving license before starting the vehicle. If no HMD-driving-license holder is seated, the HMD driving may be prohibited by warning the licensed driver that a driver who performs the existing manual driving be seated in a driver's seat stipulated by law, the warning being issued by means of voice or by causing an instrument cluster to display the warning before starting the vehicle.

(5j-3) System authentication of the HMD driving license may be performed in a host server via a network system on outside of the vehicle by wireless communication means such as 5G, the means being built, for example, in the HMD 30 or a navigation system. Alternatively, in the driving of the autonomous vehicle with the HMD driving license, the licensed driver need not necessarily be seated in a specific driver's seat before starting the vehicle. As long as the licensed driver is seated on inside or outside of the vehicle, autonomous driving may be switched to the HMD driving at any time after the system authentication of the HMD driving license.

(5j-4) Instead of physical means, specifically, the accelerator, the brake, the steering, the turn indicators, and an instrument panel, there may be provided means for causing virtual operating means that is projected onto the HMD to cooperate with means for transmitting, by using a joystick, voice recognition, gesture recognition, or the like, the intention of the licensed driver to perform driving operation (that is, simulative driving-operation system). An input apparatus of the simulative driving-operation system may be attached in a wired manner to a body of the HMD, or may have a separate structure with architecture of, for example, wireless communication system or infrared communication system.

(5j-5) Images based not on sensor information from visible-light cameras that are usually used as sensor information sources for actual images, but on sensor information from other sensor information such as an infrared or a spectral camera, or a Lidar for increasing visibility, for example, at night may be generated by an imaging process in an apparatus or by cloud computing, and may be displayed on a part or an entirety of a screen in the HMD apparatus according to selection by the driver.

(5j-6) There may be provided means for optimally selecting sensors in a group of the surroundings monitoring sensors mounted to the vehicle so that a plurality of actual images, augmented images, or synthesized images of both of these images are provided to the HMD driver. There may be adopted a configuration that allows, at this time, the driver to select arbitrary images such as real images, augmented-reality images, mixed-reality images, and virtual-reality images. For example, the driver can have options such as whether to display blind-spot-free synthesized images in which at least any of a vehicle body, seats, bodies of occupants, and the like are removed, or whether to highlight even, for example, incompletely recognized targets (such as partially-missed signs, white lines, and persons) in a complementary virtual video.

(5k) The HMD 30 may be a transmissive HMD. In this case, a person who performs the existing manual driving may wear the transmissive HMD as an auxiliary driving-information display apparatus, and may perform driving operation using the pedals such as the accelerator 22.

(5l) The authentication unit 72 of the server 70 may maintain a prepared list of driving-banned persons. The list of the driving-banned persons contain information about persons who must not be allowed to drive. Examples of the persons who must not be allowed to drive include a plurality of kinds of blacklisted persons such as terrorists, criminals, and infectious-disease carriers.

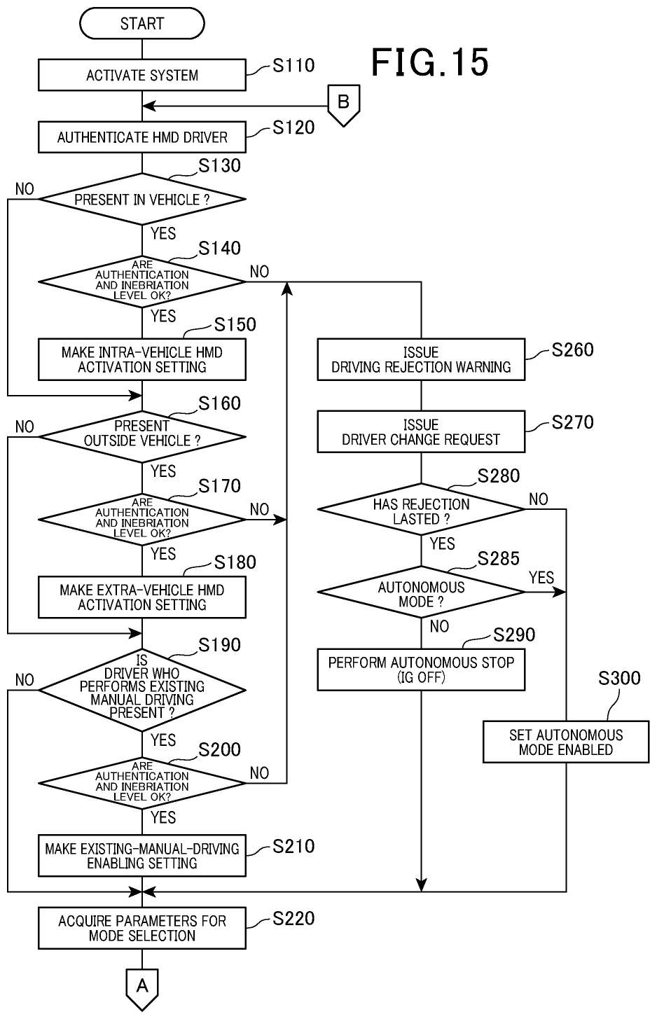

In a case of this configuration, at the time when the HMD driving unit 17 determines in S130 whether the authenticated driver is present in the vehicle 10 as shown in FIG. 15, it is preferred to anticipate that the authenticated driver be listed in the list of the driving-banned persons.

In addition, it is preferred to anticipate a case where the driver is one of the blacklisted persons at the time when the HMD driving unit 17 determines in S140, S170, and S200 that the authentication is unverified as a result of the determinations as to whether the authentication is verified and as to whether the drunkenness level of the driver is acceptable. In this case, if the HMD driving unit 17 determines in any of S140, S170, and S200 that the driver is the blacklisted person or that his/her drunkenness level is unacceptable, it is preferred that the procedure proceed to S260.

(5m) The communication status need not necessarily be determined by exchanging the test image data as in the configurations of the above-described embodiments. The vehicle 10 may receive the prepared test image data from the HMD 30 or the controller 50 without transmitting the test image data, or may transmit, instead of the test image data, other arbitrary data than data of the acquired images to the HMD 30 or the controller 50.

(5n) The vehicle 10 need not necessarily include the communication diagnosis unit 80A as in the configuration of the above-described second embodiment so that the communication condition is diagnosed in the vehicle 10.

For example, as indicated by broken lines in FIG. 12, the HMD 30 or the controller 50 may include a communication diagnosis unit 80B or 80C. When the HMD 30 includes the communication diagnosis unit 80B, the HMD 30 may include the camera unit 81B. In this configuration, it is preferred that the HMD 30 execute the communication-quality diagnosis procedure with the vehicle 10 and the controller 50 being communication counterparts.

Meanwhile, when the controller 50 includes the communication diagnosis unit 80C, the controller 50 may include the camera unit 81C. In this configuration, it is preferred that the controller 50 execute the communication-quality diagnosis procedure with the vehicle 10 and the HMD 30 being communication counterparts.

(5o) The plurality of functions of each of the plurality of components of the above-described embodiments may be implemented by the plurality of components, or one function of one of the components may be implemented by the plurality of components. Alternatively, the plurality of functions of the plurality of components may be implemented by one of the components, or one function to be implemented by the plurality of components may be implemented by one of the components. Further, some of the configurations of the above-described embodiments may be omitted. Still further, at least some of the configurations of one of the above-described embodiments may be added to or replaced with the configurations of another one of the above-described embodiments.

(5p) The present disclosure may be embodied in various forms such as not only the above-described vehicle driving system 1, but also the vehicle 10 and the wireless communication apparatus that are the components of the vehicle driving system 1, a program for causing a computer to function as a component of the vehicle driving system 1, non-transitory solid-state recording media recording this program, such as a semiconductor memory, and a method of remotely operating the vehicle.

What is claimed is:

1. A vehicle driving system comprising:
an at least one wireless communication apparatus that is possessed by a driver; and
a control-subject vehicle which is capable of manual driving and autonomous driving, and is configured to be capable of performing manual driving in response to a command from the at least one wireless communication apparatus,
the control-subject vehicle including:
at least one sensing unit that is configured to sense at least a side in an advancing direction as viewed from the control-subject vehicle to obtain a result of the sensing to generate an image to be displayed as viewed from a driver's seat of the control-subject vehicle,
an information detection unit that is configured to detect travel information of the control-subject vehicle,
an information transmission unit that is configured to transmit a sensed image based on the result of the sensing by the at least one sensing unit and travel information to the at least one wireless communication apparatus at a time when manual driving is performed, and
a driving control unit that is configured to perform acceleration/deceleration control and steering control of the control-subject vehicle in response to a driving command from the at least one wireless communication apparatus at the time when manual driving is performed,
the at least one wireless communication apparatus including:
an information acquisition unit that is configured to acquire the sensed image and travel information from the control-subject vehicle,
a display control unit that is configured to cause a display unit to display the sensed image and the image to be displayed based on travel information,
an operation accepting unit that is configured to accept a driving operation for acceleration/deceleration control and steering control of the control-subject vehicle, driving operation being performed by the driver who operates the at least one wireless communication apparatus, and
a command transmission unit that transmits a command corresponding to driving operation as the driving command to the control-subject vehicle.

2. The vehicle driving system according to claim 1, wherein
the at least one wireless communication apparatus further includes:
a controller including the operation accepting unit and the command transmission unit; and
a head-mounted type display apparatus which is separated from the controller and is mountable to a head of the driver, and the head-mounted type display apparatus includes the information acquisition unit, the display unit, and the display control unit.

3. The vehicle driving system according to claim 2, wherein
the head-mounted type display apparatus further includes a movement detection unit that is configured to detect a movement of the head of the driver, wherein
the display control unit is configured to generate the image to be displayed as viewed from a driver's seat of the control-subject vehicle, and
the display control unit is configured to change a display area of the image to be displayed in a manner of following the movements of the head, the movements being detected by the movement detection unit.

4. The vehicle driving system according to claim 2, further comprising:
a seat-position acquisition unit that is configured to acquire driver's-seat information for specifying a position of the driver's seat of the control-subject vehicle, wherein
the display control unit is configured to generate the image to be displayed from a viewpoint at a position specified based on the drive's-seat information.

5. The vehicle driving system according to claim 1, wherein
in the control-subject vehicle, as a counterpart of a first manual mode being a mode for performing manual driving, a second manual mode being a mode for manually driving the control-subject vehicle without using the at least one wireless communication apparatus is prepared, and
the control-subject vehicle further includes a mode selection unit that is configured to select any mode from a plurality of modes including the first manual mode and the second manual mode in accordance with status of malfunction of the control-subject vehicle and an intention of an occupant in the control-subject vehicle at a time when any of autonomous driving and manual driving is performed.

6. The vehicle driving system according to claim 1, further comprising:
a suitability determination unit that is configured to determine whether the driver is suited to driving of the control-subject vehicle, and
a control prohibition unit that is configured to prohibit the driving control unit from performing acceleration/deceleration control and steering control of the control-subject vehicle in response to a determination that the driver is not capable of driving.

7. The vehicle driving system according to claim 6, wherein
the suitability determination unit is configured to determine whether the driver is in a state of drunkenness, and
the control prohibition unit is configured to prohibit the driving control unit from performing acceleration/deceleration control and steering control of the control-subject vehicle in response to a determination that the driver is in the state of drunkenness.

8. The vehicle driving system according to claim 6, wherein
the suitability determination unit is configured to determine whether the driver is a preset driving-banned person, and
the control prohibition unit is configured to prohibit the driving control unit from performing acceleration/deceleration control and steering control of the control-subject vehicle in response to a determination that the driver is the preset driving-banned person.

9. The vehicle driving system according to claim any one of claim 6, further comprising:
a control notification unit that is configured to notify the at least one wireless communication apparatus that acceleration/deceleration control and steering control of the control-subject vehicle are prohibited in a case where acceleration/deceleration control and steering control of the control-subject vehicle are prohibited by the control prohibition unit.

10. The vehicle driving system according to claim 1, further comprising:
an information storage unit that is configured to store information for specifying the driver into a preset recording unit.

11. The vehicle driving system according to claim 1, wherein
the at least one sensing unit includes:
a first sensing unit that is configured to perform sensing according to a first sensing method, and
a second sensing unit that is configured to perform sensing according to a second sensing method that is different from the first sensing method, wherein
the display control unit is configured to cause the display unit to display at least one of a sensed image generated by the first sensing unit and a sensed image generated by the second sensing unit while switching the sensed images to each other in response to a command from an outside.

12. A vehicle driving system comprising:
an at least one wireless communication apparatus that is possessed by a driver; and
a control-subject vehicle which is capable of manual driving and autonomous driving, and is configured to be capable of performing manual driving in response to a command from the at least one wireless communication apparatus,
the control-subject vehicle including:
at least one sensing unit that is configured to sense at least a side in an advancing direction as viewed from the control-subject vehicle to obtain a result of the sensing to generate an image to be displayed as viewed from a driver's seat of the control-subject vehicle,
an information detection unit that is configured to detect travel information of the control-subject vehicle,
an information transmission unit that is configured to transmit a sensed image based on the result of the sensing by the at least one sensing unit and travel information to the at least one wireless communication apparatus at a time when manual driving is performed, and
a driving control unit that is configured to perform acceleration/deceleration control and steering control of the control-subject vehicle in response to a driving command from the at least one wireless communication apparatus at the time when manual driving is performed,
the at least one wireless communication apparatus including:
an information acquisition unit that is configured to acquire the sensed image and travel information from the control-subject vehicle,
a display control unit that is configured to cause a display unit to display the sensed image and the image to be displayed based on travel information,
an operation accepting unit that is configured to accept a driving operation for acceleration/deceleration control and steering control of the control-subject vehicle, driving operation being performed by the driver who operates the at least one wireless communication apparatus,
a command transmission unit that transmits a command corresponding to driving operation as the driving command to the control-subject vehicle,
the display control unit is configured to prohibit the display unit from displaying a specific image under a state in which the operation accepting unit is ready to accept driving operation, the specific image being an image of a type that is preset as a type of an image which hinders driving operation, and
the display control unit is configured to allow the display unit to display the specific image under a state in which the operation accepting unit is not ready to accept driving operation.

13. The vehicle driving system according to claim 1, wherein
one of the at least one wireless communication apparatus and the control-subject vehicle is defined as a first apparatus, and
another one of the at least one wireless communication apparatus and the control-subject vehicle is defined as a second apparatus, wherein
the vehicle driving system further comprising:
a image data reception unit that is arranged in the first apparatus, and that is configured to receive prepared test data from the second apparatus;
a communication determination unit that is configured to determine whether status of communication between the first apparatus and the second apparatus is acceptable based on status of the reception of the prepared test data; and
a use prohibiting unit that is configured to prohibit the driving control unit from performing acceleration/deceleration control and steering control of the control-subject vehicle in response to a determination by the communication determination unit that the status of the communication is poor.

14. A vehicle driving system comprising:
an at least one wireless communication apparatus that is possessed by a driver; and
a control-subject vehicle which is capable of manual driving and autonomous driving, and is configured to be capable of performing manual driving in response to a command from the at least one wireless communication apparatus,
the control-subject vehicle including:
at least one sensing unit that is configured to sense at least a side in an advancing direction as viewed from the control-subject vehicle to obtain a result of the sensing to generate an image to be displayed as viewed from a driver's seat of the control-subject vehicle,
an information detection unit that is configured to detect travel information of the control-subject vehicle,
an information transmission unit that is configured to transmit a sensed image based on the result of the sensing by the at least one sensing unit and travel information to the at least one wireless communication apparatus at a time when manual driving is performed, and
a driving control unit that is configured to perform acceleration/deceleration control and steering control of the control-subject vehicle in response to a driving command from the at least one wireless communication apparatus at the time when manual driving is performed,
the at least one wireless communication apparatus including:
an information acquisition unit that is configured to acquire the sensed image and travel information from the control-subject vehicle,
a display control unit that is configured to cause a display unit to display the sensed image and the image to be displayed based on travel information,
an operation accepting unit that is configured to accept a driving operation for acceleration/deceleration control and steering control of the control-subject vehicle, driving operation being performed by the driver who operates the at least one wireless communication apparatus,
a command transmission unit that transmits a command corresponding to driving operation as the driving command to the control-subject vehicle,
one of the at least one wireless communication apparatus and the control-subject vehicle is defined as a first apparatus, and
another one of the at least one wireless communication apparatus and the control-subject vehicle is defined as a second apparatus, wherein
the vehicle driving system further comprising:
a image data reception unit that is arranged in the first apparatus, and that is configured to receive prepared test data from the second apparatus;
a communication determination unit that is configured to determine whether status of communication between the first apparatus and the second apparatus is acceptable based on status of the reception of the prepared test data; and
a use prohibiting unit that is configured to prohibit the driving control unit from performing acceleration/deceleration control and steering control of the control-subject vehicle in response to a determination by the communication determination unit that the status of the communication is poor, wherein
the second apparatus is configured to return the prepared test data as the prepared test data originally is to the first apparatus in response to reception of the prepared test data from the first apparatus, wherein
the vehicle driving system further includes a data transmission unit that is arranged in the first apparatus, and that is configured to transmit the prepared test data to the second apparatus, and
the communication determination unit is configured to determine whether the status of the communication between the first apparatus and the second apparatus is acceptable based on an at least one of integrity of the prepared test data transmitted by the first apparatus and the prepared test data returned from the second apparatus, and a time lag from the transmission of the prepared test data by the first apparatus to reception of the prepared test data from the second apparatus.

15. The vehicle driving system according to claim 14, wherein
the first apparatus further includes an image acquisition unit that is configured to acquire an image acquired by a camera unit, and
the data transmission unit is configured to transmit image data including the acquired image as the prepared test data.
